(19) United States
(12) Patent Application Publication
(10) Pub. No.: US 2026/0336929 A1
(43) Pub. Date: Oct. 29, 2026

(54) CONDIMENT DISPENSING SYSTEM

(71) Applicant: CFA PROPERTIES, INC., Atlanta, GA (US)

(72) Inventors: Andy WU, Atlanta, GA (US); Sedef Kavasogullari JOSEPHSON, Peachtree City, GA (US); Gianni Pasquale COCCOMA, Charlotte, NC (US); Kalan Gunner PETREA, Mooresville, NC (US); Andrew Jacob BAER, Davidson, NC (US)

(21) Appl. No.: 19/657,950

(22) Filed: Apr. 24, 2026

Related U.S. Application Data
(60) Provisional application No. 63/794,060, filed on Apr. 24, 2025.

(51) Int. Cl. B65G 1/04; B25J 9/16; B25J 15/06; B65G 1/137

(52) U.S. Cl. CPC B65G 1/0464; B25J 9/1676; B25J 15/0616; B65G 1/137; B65G 2201/0235

(57) ABSTRACT

Embodiments of the present disclosure relate to a system and method for automated condiment container dispensing. An example system includes a frame comprising at least one shelf with a plurality of storage bins, at least one condiment gripper mechanism positioned at least partially superior to the shelf, at least one movement mechanism, at least one dispensing chute, and at least one controller. A respective storage bin may contain a plurality of condiment containers of one of a plurality of condiment types. The condiment gripper mechanism may include an end effector configured to secure condiment containers via a vacuum force. The movement mechanism may be configured to translate the condiment gripper mechanism along the shelf. The controller may control activation of the movement mechanism and condiment gripper mechanism to retrieve a condiment container from one of the plurality of storage bins and release the condiment container into the dispensing chute.

### CROSS REFERENCE TO RELATED APPLICATIONS

This application claims the benefit of and priority to U.S. application Ser. No. 63/794,060, filed Apr. 24, 2026, entitled “CONDIMENT DISPENSING SYSTEM,” the disclosure of which is incorporated herein by reference in its entirety.

### TECHNICAL FIELD

The present disclosure relates to systems and processes for automatically dispensing condiment containers.

### BACKGROUND

In quick service restaurants (QSRs), efficient and accurate handling of condiments is an aspect of customer satisfaction and operational efficiency. Many QSRs offer a variety of condiment options to complement their menu items. These condiments are typically stored in individual packets or containers, which need to be dispensed to customers along with their orders. Traditionally, the process of selecting and dispensing condiments has been a manual task performed by restaurant staff. This approach may be time-consuming, especially during peak hours when order volumes are high. Additionally, manual dispensing may lead to inconsistencies in the number or types of condiments provided with each order, potentially affecting customer experience. An inaccurate number of requested condiment types packaged with each order is one of the leading customer complaints for QSRs.

Different condiments may come in containers of varying sizes, shapes, and materials. For example, some condiment containers may have smooth surfaces, while others might have textured or irregular surfaces. The diversity in packet properties pose challenges to developing systems for reliably dispensing all types of condiment containers. QSRs have not yet solved the challenges of efficiently, consistently, and rapidly dispensing condiment containers.

### BRIEF SUMMARY

Embodiments of the present disclosure relate to apparatuses, devices, systems, and methods for automated condiment container dispensing. An example apparatus for automatically dispensing condiment containers may include a frame comprising at least one shelf, the at least one shelf comprising a plurality of storage bins, and a respective storage bin comprising a plurality of condiment containers of one of a plurality of condiment types. The apparatus may include at least one condiment gripper mechanism positioned at least partially superior to the at least one shelf, the at least one condiment gripper mechanism comprising an end effector. The apparatus may further include at least one movement mechanism configured to translate the at least one condiment gripper mechanism along a length of the at least one shelf, at least one dispensing chute, and at least one controller configured to control activation of the at least one movement mechanism and the at least one condiment gripper mechanism to retrieve a condiment container from one of the plurality of storage bins and release the condiment container into the at least one dispensing chute.

In some embodiments, the at least one dispensing chute comprises at least a first dispensing chute positioned along a first side of the frame and a second dispensing chute positioned along a second side of the frame opposite the first side. In some embodiments, the frame comprises a plurality of shelves spaced vertically apart from one another, a respective shelf of the plurality of shelves comprising a respective plurality of storage bins. In such embodiments, respective shelves of the plurality of shelves comprise a respective first dispensing chute positioned along the first side of the frame and a respective second dispensing chute positioned along the second side of the frame, and the at least one condiment gripper mechanism comprises a plurality of condiment gripper mechanisms, a respective condiment gripper mechanism of the plurality of condiment gripper mechanisms associated with a respective shelf of the plurality of shelves.

In some embodiments, the apparatus further comprises at least one accumulation zone positioned at a lower portion of the frame, the at least one accumulation zone configured to receive condiment containers released through the at least one dispensing chute. In some embodiments, a removable receptacle is positioned at the at least one accumulation zone, the removable receptacle configured to receive dispensed condiment containers and to be lifted from the at least one accumulation zone for transfer of the dispensed condiment containers into a bag, tray, or other container. In some embodiments, the apparatus further comprises at least one ramp configured to guide dispensed condiment containers from the at least one dispensing chute toward the at least one accumulation zone along a descent path.

In some embodiments, the at least one condiment gripper mechanism further comprises a gripper arm connecting the end effector to the at least one movement mechanism, the gripper arm configured to adjust a vertical position of the end effector between a raised position and a lowered position. In such embodiments, the gripper arm may comprise a plurality of pivot joints configured to articulate the gripper arm between the raised position and the lowered position. In some embodiments, the apparatus further comprises at least one vision sensor configured to capture image data of the plurality of storage bins, and the at least one controller is configured to determine, based on the image data, positions and orientations of condiment containers within the plurality of storage bins for directing the at least one condiment gripper mechanism during retrieval operations. In some embodiments, the apparatus further comprises a suspension control operably coupled to the at least one controller, the suspension control configured to receive a user input and, in response to the user input, cause the at least one controller to selectively suspend or resume automated dispensing operations of the at least one condiment gripper mechanism.

Another example apparatus for automatically dispensing condiment containers may include a frame comprising a plurality of shelves spaced vertically apart from one another, a respective shelf comprising a plurality of storage bins, a respective storage bin configured to store a plurality of condiment containers of a respective condiment type. The apparatus may include a plurality of condiment gripper mechanisms, a respective condiment gripper mechanism positioned at least partially superior to a respective shelf and comprising a gripper arm with a plurality of pivot joints and an end effector connected to the gripper arm, the end effector configured to secure a condiment container via a vacuum force. The apparatus may include a plurality of movement mechanisms, wherein a respective movement mechanism is configured to translate a respective condiment gripper mechanism along a length of the respective shelf. The apparatus may include a plurality of dispensing chutes comprising a first subset of dispensing chutes positioned along a first side of the frame and a second subset of dispensing chutes positioned along a second side of the frame opposite the first side. The apparatus may include a plurality of accumulation zones positioned at a lower portion of the frame, a respective accumulation zone configured to receive condiment containers released through at least one of the plurality of dispensing chutes. The apparatus may also include at least one controller configured to receive order data associated with at least one order from a kitchen production system (KPS), the order data defining at least one condiment type and at least one condiment quantity, control activation of the movement mechanism and the end effector of at least one of the plurality of condiment gripper mechanisms to retrieve a condiment container from one of the plurality of storage bins based at least in part on the order data, and cause the at least one of the plurality of condiment gripper mechanisms to transport the condiment container to a designated dispensing chute of the plurality of dispensing chutes and release the condiment container therein for conveyance to a corresponding accumulation zone of the plurality of accumulation zones.

In some embodiments, the apparatus further comprises at least one vision sensor configured to capture image data of the plurality of storage bins, and the at least one controller is further configured to determine, based on the image data, positions and orientations of condiment containers within the plurality of storage bins and control the at least one of the plurality of condiment gripper mechanisms to retrieve the condiment container based at least in part on the determined positions and orientations. In some embodiments, the at least one controller is further configured to detect a presence of a human hand within one of the plurality of storage bins and, in response to the detection, suspend automated operations of a respective condiment gripper mechanism associated with the one of the plurality of storage bins.

In some embodiments, the apparatus further comprises at least one display operably coupled to the at least one controller. In such embodiments, the order data defines a plurality of condiment types and a respective condiment quantity for a respective condiment type of the plurality of condiment types, and the at least one controller is further configured to track dispensing of condiment containers into the designated dispensing chute, determine, based on the tracked dispensing, that the respective condiment quantity for the respective condiment type of the plurality of condiment types associated with the at least one order has been fulfilled, and in response to the determination, cause the at least one display to render an indication that the at least one order is complete. In some embodiments, the at least one controller is further configured to determine a fill level of at least one of the plurality of storage bins based at least in part on data from at least one sensor and cause at least one visual indicator to display a color corresponding to the determined fill level.

An example method for automatically dispensing condiment containers may include receiving, by at least one controller, order data associated with at least one order, the order data defining at least one condiment type and at least one condiment quantity. The method may include translating, based at least in part on the order data, at least one condiment gripper mechanism along a guide rail of a frame to a position aligned with a storage bin containing the at least one condiment type, the storage bin being one of a plurality of storage bins supported by the frame. The method may further include lowering an end effector of the at least one condiment gripper mechanism toward a condiment container within the storage bin, securing the condiment container to the end effector via a vacuum force, raising the end effector with the secured condiment container, translating the at least one condiment gripper mechanism along the guide rail to a position aligned with a designated dispensing chute of a plurality of dispensing chutes, and releasing the condiment container into the designated dispensing chute for conveyance to a corresponding accumulation zone.

In some embodiments, the method further comprises conveying the condiment container through the designated dispensing chute to the corresponding accumulation zone and repeating the translating, lowering, securing, raising, translating, and releasing for at least one additional condiment container until the at least one condiment quantity is fulfilled. In some embodiments, the order data is received from a kitchen production system (KPS). In some embodiments, the method further comprises detecting a presence of a human hand within one of the plurality of storage bins and, in response to the detecting, suspending automated operations of the at least one condiment gripper mechanism for the one of the plurality of storage bins while continuing automated operations for other storage bins of the plurality of storage bins.

In some embodiments, the at least one order comprises a first order and a second order. In such embodiments, the method further comprises causing a first condiment gripper mechanism to transport a first condiment container associated with the first order to a first dispensing chute and release the first condiment container therein for conveyance to a first accumulation zone, and causing a second condiment gripper mechanism to transport a second condiment container associated with the second order to a second dispensing chute and release the second condiment container therein for conveyance to a second accumulation zone distinct from the first accumulation zone.

### BRIEF DESCRIPTION OF FIGURES

Having thus described the embodiments of the disclosure in general terms, reference now will be made to the accompanying drawings, which are not necessarily drawn to scale, and wherein:

FIG. 1 illustrates an example restaurant environment;

FIG. 2 illustrates a front view of an example condiment dispensing system in accordance with some embodiments of the present disclosure;

FIG. 3 illustrates a partial perspective view of a portion of an example condiment dispensing system in accordance with some embodiments of the present disclosure;

FIG. 4 illustrates a partial perspective view of a portion of an example condiment dispensing system in accordance with some embodiments of the present disclosure;

FIG. 5 illustrates a partial perspective view of a portion of an example condiment dispensing system in accordance with some embodiments of the present disclosure;

FIG. 6 illustrates a perspective view of an example condiment gripper mechanism in accordance with some embodiments of the present disclosure;

FIG. 7 illustrates a perspective view of an example condiment gripper mechanism in accordance with some embodiments of the present disclosure;

FIG. 8 illustrates a perspective view of an end effector in accordance with some embodiments of the present disclosure;

FIG. 9 illustrates a side-by-side comparison of different end effector configurations in accordance with some embodiments of the present disclosure;

FIG. 10 illustrates a perspective view of an example condiment dispensing system in accordance with some embodiments of the present disclosure;

FIG. 11 illustrates a front perspective view of an example condiment dispensing system in accordance with some embodiments of the present disclosure;

FIG. 12 illustrates a front view of an example condiment dispensing system in accordance with some embodiments of the present disclosure;

FIG. 13 illustrates a perspective view of an example condiment gripper mechanism in accordance with some embodiments of the present disclosure;

FIG. 14 illustrates a perspective view of an example condiment gripper mechanism in a lowered position in accordance with some embodiments of the present disclosure; and

FIG. 15 illustrates a perspective view of a portion of an example condiment gripper mechanism in accordance with some embodiments of the present disclosure.

### DESCRIPTION

In general, various embodiments of the present disclosure provided improved systems for gripping and dispensing objects. For purposes of describing and illustrating exemplary aspects of the condiment dispensing system, the proceeding description is presented in the context of gripping and dispensing condiment containers. It will be understood and appreciated that such context is provided by way of example and uses of the system in additional contexts, such as with other objects, are contemplated and within the scope of the invention. For example, the present dispensing systems may be utilized for gripping and dispensing food ingredients, food packaging, beverage containers, utensils, and/or the like.

In QSRs, condiments may be provided to customers alongside their orders. Typically, a human staff member must manually retrieve condiment containers from a supply container, or a customer must manually retrieve or dispense their own condiments. Manual retrieval of condiments by human staff members may reduce throughput of the QSR. Additionally, human error may result in incorrect dispensing of condiments, thereby reducing order fulfillment accuracy and customer satisfaction. Manual retrieval of condiments by customers may be prone to excess consumption, which may increase resource costs and decreasing the overall availability of condiment types, such as those most favored by customers. Automation technologies may be leveraged to offload condiment dispensing duties from human staff members and customers. However, the automation of condiment dispensing presents unique challenges due to the variety of condiment types, packet sizes, and storage configurations used across different establishments.

To address these challenges, and others, the present disclosure provides an improved condiment dispensing system for automated dispensing of condiment containers in QSR environments. In various embodiments, the condiment dispensing system addresses challenges in condiment handling by improving efficiency, consistency, and versatility in dispensing operations. In some embodiments, the condiment dispensing system enables automatic dispensing of condiment containers while maintaining the ability for human team members to manually access the condiment bins. This dual-access functionality may provide flexibility in operations, allowing for seamless transitions between automated and manual dispensing as needed. By preserving manual access, the condiment dispensing system may accommodate situations where human intervention is preferred or necessary. In some embodiments, the condiment dispensing system may be configured to automatically resume automated operations upon detecting that manual interaction has ceased, such as when a team member removes their hand from a storage bin. This automatic resumption may eliminate the need for manual re-engagement of the system via a console or other input device, thereby reducing workflow interruptions and maintaining operational efficiency. The implementation of the condiment dispensing system may lead to improved throughput in condiment dispensing operations. For example, during peak hours or high-volume periods, the condiment dispensing system may handle a significant portion of condiment dispensing tasks, potentially reducing wait times and increasing overall efficiency.

Additionally, the condiment dispensing system may offer adaptability to varying order volumes. In some cases, the system may be configured to be disabled during periods of low order volume, allowing staff to handle the reduced workload manually. Conversely, the system may be re-enabled when order volumes increase, providing additional support during busy periods. This scalability may allow restaurants to optimize their resources and adjust their operations based on real-time demand. In some embodiments, the condiment dispensing system may incorporate intelligent task routing capabilities to dynamically allocate dispensing tasks between automated and manual fulfillment. For example, the condiment dispensing system may predict when a team member is likely to manually retrieve a condiment, such as when a collection area is full or when there is a timing mismatch between automated dispensing and order assembly. In response to such predictions, the condiment dispensing system may preemptively route one or more remaining condiment items to manual fulfillment rather than dispensing condiments that may sit uncollected. This predictive routing may optimize the coordination between automated and manual operations, reducing delays and improving overall workflow efficiency. Additionally, the condiment dispensing system may ensure that order fulfillment accuracy remains high as order volume scales. Further, the condiment dispensing system may be configured to automatically enforce condiment dispensing limits, which may ensure order fulfillment operations align with inventory policies.

### Existing Approach

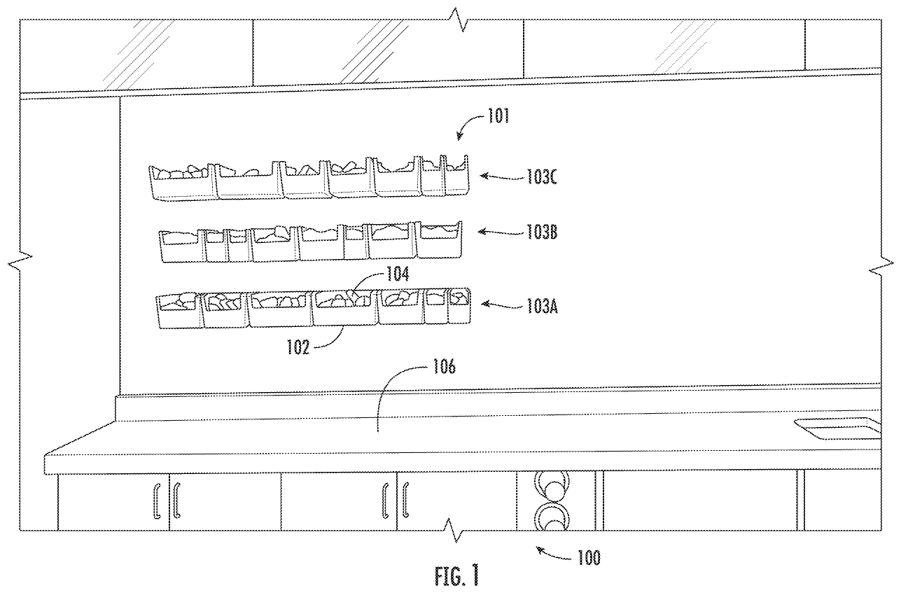

FIG. 1 illustrates an example quick service restaurant (QSR) environment 100. The QSR environment 100 includes a condiment service area 101 upon which orders may be staged and placed into or onto containers, such as trays or bags. In some instances, multiple bins 102 are arranged in rows 103A, 103B, and 103C along the condiment service area 101. The storage bins 102 may contain various condiment containers 104, such as containers of different sauce varieties, dressings, spices, toppings, and/or the like. The storage bins 102 may each include only one type of condiment, such as ketchup containers in one or more of the storage bins, ranch dressing in another storage bin, specialty sauces in other storage bins, etc. Additionally, one or more condiment containers 104 may comprise utensils, such as forks, knives, straws, napkins, and/or the like. In this setup, a human worker is required to manually retrieve condiments from the storage bins 102 when fulfilling customer orders. The workspace surface 106 extends horizontally below the condiment service area, providing an area for condiment handling and order preparation activities, such as bagging.

The manual approach to condiment dispensing presents several potential drawbacks that may impact restaurant operations and customer experiences. Inefficiency in the process may lead to increased time spent on selecting and retrieving condiments, potentially slowing down order fulfillment, especially during busy periods. This manual retrieval may also result in inconsistencies in the number or types of condiments provided with each order, affecting customer satisfaction. Additionally, human error in selecting incorrect condiment types or quantities may lead to order inaccuracies.

From an operational standpoint, dedicating staff time to condiment retrieval may increase labor costs and reduce overall efficiency. There are also hygiene considerations associated with frequent handling of condiment containers by multiple staff members. The manual process may create bottlenecks in order fulfillment during high-volume periods, as it may not easily scale to meet increased demand. Furthermore, manual dispensing may make it challenging to accurately track condiment usage and maintain optimal inventory levels. Ergonomic issues may arise from repetitive reaching and bending to access storage bins 102, potentially leading to worker fatigue over time. Lastly, the time required for manual condiment retrieval may contribute to longer customer wait times and make it difficult to efficiently accommodate complex or customized condiment requests. In various embodiments, the condiment dispensing systems described herein address these challenges by automatically retrieving and dispensing condiment containers 104 from their respective bins 102.

### Example Condiment Dispensing System

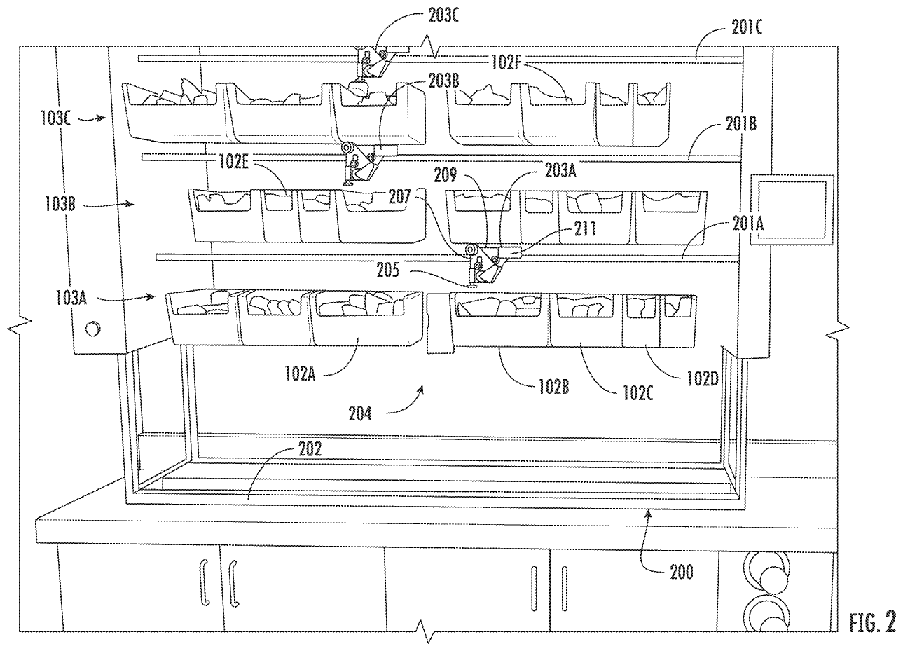

FIG. 2 depicts an exemplary condiment dispensing system 200. In some embodiments, the condiment dispensing system 200 is integrated into the condiment service area 101. For example, the condiment dispensing system 200 may be integrated amidst a region comprising storage bins 102. In various embodiments, the condiment dispensing system 200 is configured to selectively retrieve and dispense condiment containers 104 to fulfill orders automatically and/or in response to a user input. In various embodiments, an automated process of aligning, securing, repositioning, and releasing condiment containers may improve efficiency and accuracy in condiment dispensing operations. In some embodiments, the condiment dispensing system 200 maintains the existing footprint of the condiment storage area while adding automated capabilities, potentially reducing manual handling and improving order fulfillment speed.

In various embodiments, the condiment dispensing system 200 includes a frame 202 configured to support a plurality of guide rails 201A, 201B, 201C that are spaced vertically and/or horizontally apart from one another. In some embodiments, an inner portion of the frame 202 is configured to accommodate an arrangement of storage bins 102. For example, the frame 202 may be integrated over storage bins 102 arranged in rows 103A, 103B, 103C.

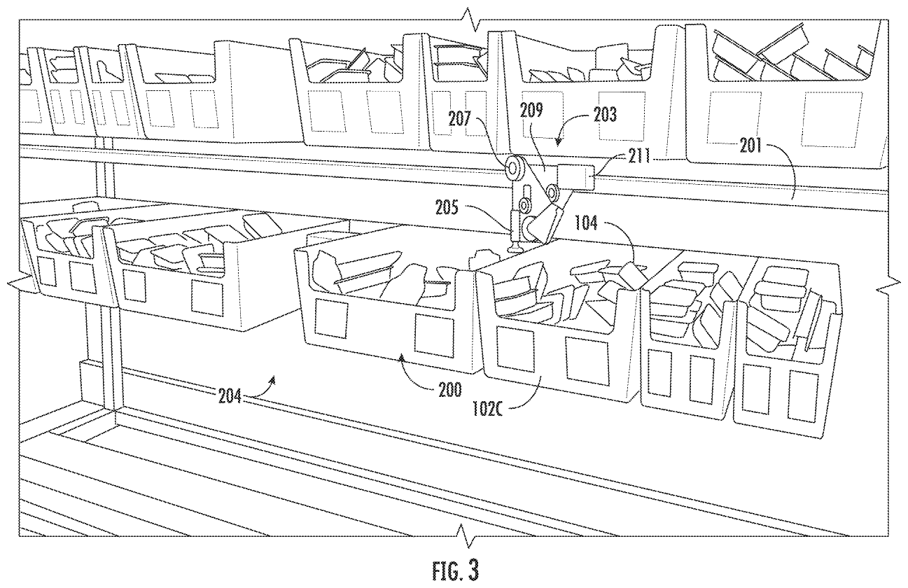

In some embodiments, a respective condiment gripper mechanism comprises several components that work together to carry out automated condiment retrieval and dispensing functions. In some embodiments, the condiment dispensing system 200 includes multiple condiment gripper mechanisms 203A, 203B, 203C positioned along the respective guide rails 201A, 201B, 201C. In some embodiments, a respective condiment gripper mechanism 203A, 203B, 203C comprises an end effector 205, gripper arm 207, movement mechanism 209, and one or more vision sensors 211. In some embodiments, the condiment dispensing system 200 includes one or more controllers configured to coordinate the operation of the condiment gripper mechanisms 203A, 203B, 203C, movement mechanisms 209, and end effectors 205. In some embodiments, the controller receives order information from a kitchen production system (KPS) and controls retrieval and dispensing operations based on the order requirements. In some embodiments, an end effector 205 connects to and extends downward from the gripper arm 207. In various embodiments, the gripper arm 207 is configured to adjust a vertical position of the end effector 205 to facilitate condiment retrieval. For example, as shown in FIGS. 3-7, the gripper arm 207 may transition between raised and lowered positions during condiment retrieval and dispensing.

In some embodiments, the movement mechanism 209 is configured to engage with a guide rail to translate the condiment gripper mechanism across the condiment service area 101. For example, the movement mechanism 209 may horizontally translate the condiment gripper mechanism into a position that is vertically aligned with a storage bin 102 or a condiment container 104 therein. In some embodiments, the vision sensor 211 is configured to generate image data based upon which condiment containers 104 may be identified and mapped to direct the condiment gripper mechanism for condiment retrieval.

In some embodiments, a dispensing chute 204 provides a pathway for releasing secured condiment containers 104. In some embodiments, when aligned over the dispensing chute 204, the end effector 205 may release the condiment container 104, allowing the condiment container 104 to drop through the dispensing chute 204 for output to a team member or into a container, such as a bag or tray. In some embodiments, the dispensing chute 204 is centrally located within the frame 202. In some embodiments, one or more dispensing chutes are positioned along the sides of the frame 202 to enable side-drop configurations.

In some embodiments, the condiment dispensing system 200 incorporates multiple condiment gripper mechanisms 203A, 203B, 203C positioned along guide rails 201A, 201B, 201C, enabling efficient and precise retrieval of condiment containers 104 from various storage bins 102. In some embodiments, the end effector 205 serves as the primary interface between the condiment dispensing system 200 and the condiment containers 104. In various embodiments, the end effector 205 is configured to securely grasp and release containers of various sizes, shapes, and materials. In some embodiments, the end effector 205 utilizes suction, mechanical gripping, or a combination of techniques to ensure reliable handling of diverse condiment packaging. In some embodiments, connected to the end effector 205 is a gripper arm 207, configured to articulate upward and downward to facilitate condiment retrieval. In some embodiments, the articulation of the gripper arm 207 enables precise vertical positioning and potentially some degree of angular adjustment to reach into storage bins 102 and position the end effector optimally for grasping condiment containers 104.

In some embodiments, the movement mechanism 209, mounted in the upper portion of the assembly, is configured to enable the horizontal translation of the entire condiment gripper mechanism 203A, 203B, 203C along its respective guide rail 201A, 201B, 201C. In some embodiments, the movement mechanism 209 enables a condiment gripper mechanism to access different storage bins 102 along a row. In some embodiments, the vision sensor 211 generates image data, which may be analyzed via one or more image processing algorithms to identify specific condiment types, assess their orientation within the storage bin 102, and guide the positioning of the end effector 205 for retrieval. In some embodiments, the vision sensor 211 also contributes to inventory management by monitoring condiment levels in one or more storage bins 102. In some embodiments, the combination of these components creates a versatile condiment handling system that allows for adaptive and accurate condiment dispensing, potentially improving efficiency in quick-service restaurant operations.

In various embodiments, the condiment dispensing system 200 offers several advantages over existing manual approaches described in relation to FIG. 1. In some embodiments, by automating the condiment retrieval process, the condiment dispensing system 200 may substantially increase efficiency and throughput, especially during peak order periods. In some embodiments, the movement mechanism 209, gripper arm 207, vision sensor 211, and/or the like, enable precise targeting and grasping of specific condiment types from different storage bins, reducing errors in order fulfillment. In some embodiments, the condiment dispensing system 200 is configured to enforce consistent dispensing policies, helping to manage inventory and reduce waste.

In some embodiments, unlike manual retrieval methods that may lead to fatigue or repetitive strain for workers, the condiment dispensing system 200 may operate continuously without such limitations. In some embodiments, the condiment dispensing system 200 allows for retrofitting existing condiment storage setups, as evidenced by the preservation of the familiar bin arrangement in rows 103A, 103B, 103C. In various embodiments, such compatibility enables QSR operators to upgrade their condiment handling capabilities without a complete overhaul of their current infrastructure.

In some embodiments, the condiment dispensing system 200 maintains the option for manual access to condiment containers 104 when desired. In some embodiments, the storage bins 102A-E are positioned at angles that facilitate both automated and manual retrieval, providing flexibility in operations. In some embodiments, this dual-mode functionality allows staff to intervene or take over condiment dispensing tasks as needed, such as during system maintenance or for custom orders. For example, the combination of condiments to be provided with each order may be predetermined by the menu of QSR (such as a certain type of salad dressing being paired by default with a certain type of salad), by a customer remotely ordering from an app before arriving at the QSR, or by a customer in a drive-thru or at the counter. These condiment orders are entered into a kitchen production system (KPS) so that kitchen and fulfillment workers may view the condiment order on various work screens. However, customers may change their minds after an order has been placed and entered into the system. For example, customers may request additional or alternative condiments at last minute before order completion, such as while sitting at the final drive-thru window or while standing at the counter. The embodiments of the condiment dispensing system 200 here allow the condiments entered into the KPS to be completed by the gripper mechanism retrieving condiments from a storage bin, whereas the supplemental condiments may be manually retrieved from the same storage bin placed into the order bag or on the tray by a worker. The condiment dispensing system thus advantageously functions as a collaborative robot, or cobot.

In various embodiments, the condiment dispensing system 200 is configured to operate selectively based on the complexity of condiment orders. For example, the condiment dispensing system 200 may include logic to determine when to engage or disengage automated dispensing operations depending on factors such as the number of condiments requested or the variety of condiment types in an order. In some embodiments, the adaptive functionality optimizes efficiency by balancing automated and manual dispensing methods. In some embodiments, the condiment dispensing system 200 is configured to remain inactive for simpler orders, such as those requiring only one or two condiment containers 104. In such instances, manual retrieval by team members may be more time efficient. When an order includes a larger number of condiments or a wider variety of condiment types, the condiment dispensing system 200 may automatically engage to handle the more complex dispensing task. In some embodiments, the conditional engagement of the condiment dispensing system 200 streamlines operations during peak hours or for intricate orders, while allowing for quick manual dispensing during slower periods or for straightforward requests. The threshold for system engagement may be adjustable based on factors such as current order volume, current or forecasted restaurant occupancy, staff availability, specific restaurant preferences, and/or the like.

In various embodiments, the integration of a dispensing chute 204 into the condiment dispensing system 200 streamlines the transfer of retrieved condiments, potentially reducing the time and complexity involved in order assembly. In some embodiments, the dispensing chute 204 includes a sloped surface to help control the descent of condiments dropped from higher rows. In some embodiments, the sloped surface reduces impact forces on the condiment containers 104 as they travel down the dispensing chute 204. In some embodiments, by centralizing the condiment dispensing location, the condiment dispensing system 200 contributes to a more organized and efficient order fulfillment process compared to manual methods that may involve reaching across multiple bin locations. In some embodiments, the condiment dispensing system 200 includes multiple dispensing chutes positioned at different locations to support different routing configurations and parallel order fulfillment.

FIG. 3 illustrates a perspective view of a portion of the condiment dispensing system 200. As shown in FIG. 3, the condiment gripper mechanism 203 may be translated along the guide rail 201 into a position aligned over a storage bin, such as the storage bin 102C. In some embodiments, in the aligned position, the end effector 205 is aligned with a condiment container 104 held within the storage bin 102C. In some embodiments, a position of alignment between the end effector 205 and a condiment container 104 within a storage bin may be based at least in part on data from one or more sensors. For example, the vision sensor 211 may generate image data, video data, and/or the like, which may be an input to processes for aligning the end effector 205 over a target condiment container 104.

In some embodiments, the movement mechanism 209 may interface with the guide rail 201 to enable horizontal translation of the condiment gripper mechanism 203 across a row of storage bins 102. In various embodiments, this movement capability allows the condiment dispensing system 200 to access different types of condiment containers 104 stored in various bins 102.

In some embodiments, the gripper arm 207 extends downward from the movement mechanism 209 and is connected to the end effector 205. In some embodiments, the vision sensor 211 may be integrated into the upper portion of the assembly to assist in detecting and locating specific condiment containers 104 within the storage bins 102. The vision sensor 211 may be capable of determining the orientation of the condiments in the storage bins and adjusting the end effector position accordingly to adequately retrieve the condiments. In addition, the vision sensor 211 may be capable of determining various condiment types based on their packaging, in terms of the container shapes, printed indicia on the packaging and the like, such as when multiple condiment types are placed into one storage bin, or when the type of condiments kept on one storage bin is changed to a different condiment type. In various embodiments, the end effector 205 may utilize suction or mechanical gripping to secure a condiment container 104. In some embodiments, once a condiment container 104 is gripped, the movement mechanism 209 may reposition the condiment gripper mechanism 203 to align with the centrally located dispensing chute 204.

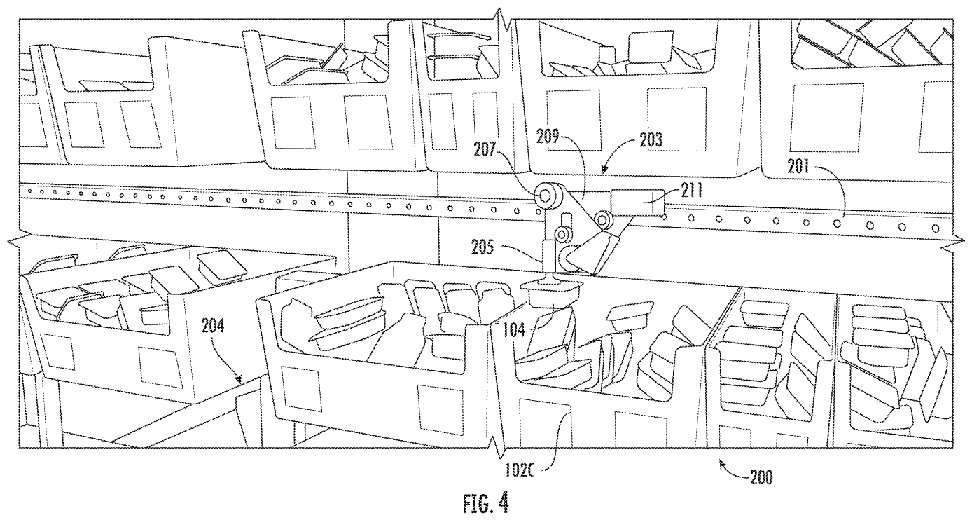

FIG. 4 illustrates a perspective view of a portion of the condiment dispensing system 200. FIG. 4 may depict a subsequent operation of the condiment dispensing system relative to FIG. 3. For example, the condiment gripper mechanism 203 may be positioned over a storage bin 102C. The end effector 205 is shown aligned with a condiment container 104 within the storage bin 102C. For example, the movement mechanism 209 may translate the condiment gripper mechanism 203 horizontally to the position shown. In some embodiments, translation of the condiment gripper mechanism 203 is performed automatically based at least in part on a customer order, a user input, and/or the like.

In some embodiments, the gripper arm 207 extends downward, lowering the end effector 205 towards the condiment container 104. In some embodiments, as the end effector 205 makes contact with the condiment container 104, a vacuum force is applied through the end effector to temporarily secure the condiment container 104. The vacuum force may secure the condiment container 104 to the end effector 205 such that the condiment gripper mechanism 203 may lift and transport the selected condiment container 104 for dispensing. For example, the vacuum force may be sufficient to secure the condiment container 104 to the end effector 205 as the gripper arm 207 articulates to a raised position and as the movement mechanism 209 translates the condiment gripper mechanism 203 into alignment with the dispensing chute 204.

In various embodiments, the gripper arm 207 may be configured with multiple articulation points to enable precise movement between raised and lowered positions. In some embodiments, in a raised position, the gripper arm 207 may be retracted closer to the movement mechanism 209, allowing for unobstructed horizontal translation along the guide rail 201. In some embodiments, when a target condiment container 104 is identified, the gripper arm 207 may extend downward, lowering the end effector 205 towards the storage bin 102C. In some embodiments, the articulation points may allow for fine adjustments in the vertical and angular positioning of the end effector 205, ensuring optimal alignment with the condiment container 104. In some embodiments, once the end effector 205 secures the condiment container 104, the gripper arm 207 may retract to a partially raised position, lifting the condiment container 104 clear of the storage bin 102C. This position also allows a worker to place his or her hand into the storage bin 102C to retrieve one or more condiments therefrom. In some embodiments, the gripper arm 207 may then fully raise to a transport position, allowing the movement mechanism 209 to translate the secured condiment container 104 to the dispensing chute 204. In some embodiments, the articulation capability of the gripper arm 207 enables efficient transitions between retrieval, transport, and dispensing operations while maintaining a compact overall system footprint.

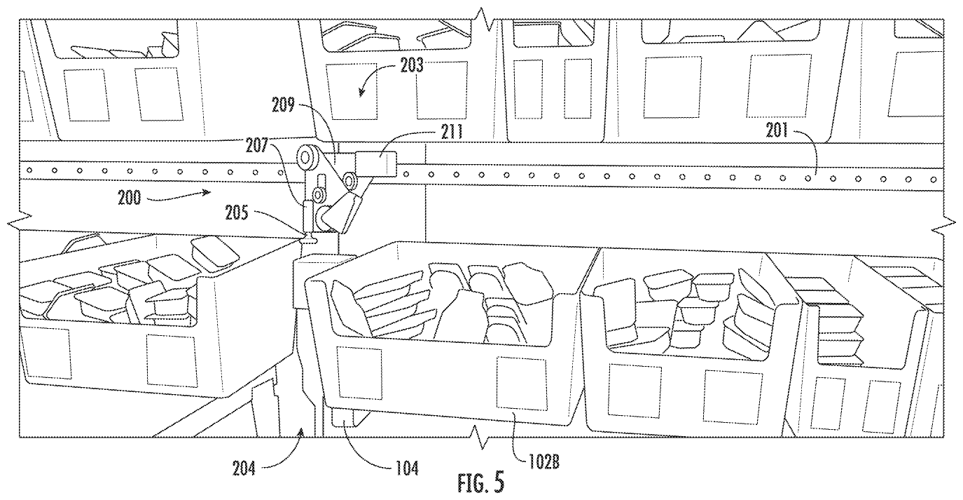

FIG. 5 a perspective view of a portion of the condiment dispensing system 200. In various embodiments, FIG. 5 depicts a further stage of the automated condiment dispensing process relative to FIGS. 3 and 4. For example, FIG. 5 depicts the condiment gripper mechanism 203 in a dispensing position in which the end effector 205 is in alignment with the dispensing chute 204. In some embodiments, after successfully retrieving a condiment container 104 from a storage bin 102C, as detailed in FIGS. 3 and 4, the condiment dispensing system 200 utilizes horizontal and/or vertical translation capabilities to precisely position the end effector 205 over the dispensing chute 204. In some embodiments, this movement is facilitated by the guide rail 201 and movement mechanism 209, which work in tandem to ensure accurate alignment.

In various embodiments, once properly positioned, the condiment dispensing system 200 initiates a release sequence. In some embodiments, the gripping force applied by the end effector 205, which may utilize vacuum technology for secure hold, is deactivated. In some embodiments, this controlled release allows the condiment container 104 to drop smoothly into the dispensing chute 204. In some embodiments, the dispensing chute 204 channels the released condiment container 104 to an intended destination, which may vary depending on the specific operational setup of the QSR (e.g., tray, bag, countertop, team member's hand, customer's hand, and/or the like). In some embodiments, the condiment dispensing system 200 is configured to prevent release of multiple condiment containers 104 into the dispensing chute 204 simultaneously, to avoid clogging, breakage, and/or misplacement of condiment containers 104 across orders. For example, the condiment dispensing system 200 may be configured to control the respective end effector 205 of a plurality of condiment gripper mechanisms 203A, 203B, 203C to prevent overlapping releases of condiment containers into the dispensing chute 204.

Additionally, or alternatively, in some embodiments, the condiment dispensing system 200 includes multiple dispensing chutes 204, which may be associated with different condiment gripper mechanisms. In some embodiments, a condiment service area 101 includes multiple order fulfillment stations. The condiment dispensing system 200 may include a respective dispensing chute 204 for one or more of the order fulfillment stations. The condiment dispensing system 200 may be configured to transport condiment containers 104 to a dispensing chute 204 that is associated with a particular order fulfillment station. In doing so, multiple, overlapping condiment orders may be fulfilled in parallel.

In some embodiments, the dispensing chute 204 offers versatility in its output options. In some embodiments, the dispensing chute 204 may direct the condiment container 104 to a designated area for a team member to collect and incorporate into an order, streamlining the manual aspect of order assembly. In some embodiments, in more automated setups, the dispensing chute 204 may be configured to dispense directly into a customer's tray or bag, further reducing handling steps and potentially increasing efficiency.

In some embodiments, the condiment dispensing system 200 includes multiple dispensing chutes 204, which may be associated with different condiment gripper mechanisms 203A, 203B, 203C. For example, a condiment service area 101 may include multiple accumulation zones, and the condiment dispensing system 200 may include a respective dispensing chute 204 for each or subsets of the accumulation zones. In such configurations, the condiment dispensing system 200 may be configured to transport condiment containers 104 to a dispensing chute 204 that is associated with a particular accumulation zone, enabling multiple, overlapping condiment orders to be fulfilled in parallel. In some embodiments, dispensing chutes are positioned along opposing sides of the frame 202, enabling condiment containers 104 to be dropped to different dispensing chutes based on the intended destination. In some embodiments, this side-drop configuration simplifies routing of condiment containers 104 and reduces the overall depth of the condiment dispensing system 200. In some embodiments, slides or ramps direct condiments from side-aligned chutes toward the accumulation zones for collection by team members.

In various embodiments, the condiment dispensing system 200 seamlessly transitions from condiment identification and retrieval to precise delivery, while maintaining the flexibility to integrate with existing restaurant workflows. In some embodiments, the automation of dispensing contributes to the overall efficiency gains provided by the condiment dispensing system 200, reducing the time and potential for error associated with manual condiment handling and dispensing.

In various embodiments, the condiment dispensing system 200 incorporates safety features to prevent collisions between the condiment gripper mechanism 203 and team members accessing the storage bins 102 manually. In some embodiments, the condiment dispensing system 200 utilizes sensors to detect the presence of a human hand or arm within a storage bin 102. For example, the vision sensor 211 or additional proximity sensors may be configured to monitor the space within and around each storage bin 102. In some embodiments, when a team member's hand is detected within a storage bin 102, the condiment dispensing system 200 automatically prevents the condiment gripper mechanism 203 from lowering into that particular bin 102. This safety measure may be implemented through software interlocks that temporarily disable the movement of the gripper arm 207 or the entire condiment gripper mechanism 203 for the affected bin 102.

In some embodiments, the condiment dispensing system 200 provides visual or auditory feedback to alert team members when automated access to a particular bin 102 is temporarily restricted due to manual interaction. For instance, indicator lights may be integrated near each storage bin 102 to signal when the storage bin 102 is available for automated retrieval or currently in use by a team member. In some embodiments, the condiment dispensing system 200 implements a time-based approach, where manual access to a storage bin 102 triggers a brief pause in automated operations for that specific bin 102. This pause may allow team members to complete their manual retrieval without interference from the automated system. After a predetermined time interval, or upon detecting that the manual interaction has ceased, the condiment dispensing system 200 may resume normal automated operations for the affected bin 102. In some embodiments, the safety features may extend beyond individual bin access. The condiment dispensing system 200 may be programmed to reduce the speed of translations along the guide rail 201 when team members are detected in proximity to the condiment storage area. This adaptive speed control may further enhance safety while maintaining operational efficiency.

In various embodiments, while the condiment gripper mechanism 203 is shown moving along a horizontal axis, the condiment dispensing system 200 may be configured to enable movement along multiple axes. In some embodiments, the condiment gripper mechanism 203 may additionally or alternatively move along any number of axes in the X, Y, and Z directions. This multi-axial movement capability may enhance the flexibility and adaptability of the condiment dispensing system 200 to different condiment storage configurations. For example, in some embodiments, the condiment gripper mechanism 203 may incorporate vertical movement along the Z-axis, allowing the condiment gripper mechanism 203 to access storage bins 102 arranged at different heights, diagonals, and/or the like. This vertical mobility may enable the condiment dispensing system 200 to accommodate multi-tiered storage arrangements or reach condiment containers 104 positioned at various levels within a single bin 102.

In various embodiments, the condiment dispensing system 200 includes one or more condiment gripper mechanisms 203 configured for movement along a Y-axis, perpendicular to the shown horizontal movement. In some embodiments, an additional (or alternative) degree of freedom may enable the condiment gripper mechanism 203 to access storage bins 102 arranged in a grid-like pattern, potentially increasing the storage capacity and variety of condiments that may be handled by a single system. In some embodiments, the combination of movement along multiple axes may enable more complex trajectories for the condiment gripper mechanism 203. This enhanced mobility may allow the condiment dispensing system 200 to navigate around obstacles, optimize its path for efficiency, or access condiment containers 104 stored in irregularly shaped or positioned bins 102. For example, some walls may include multiple regions of storage bins 102 interspersed between other systems or wall features. In some embodiments, the condiment gripper mechanism 203 is configured to translate in multiple axial directions (e.g., combinations of X, Y, and/or Z axis-directed movement) to navigate between separated or divided condiment storage regions. The multi-axial movement capability may, in various embodiments, contribute to the scalability and adaptability of the condiment dispensing system 200 to different restaurant layouts and operational needs. In some embodiments, multi-axial movement may enable more compact storage arrangements while maintaining the ability of the condiment dispensing system 200 to access all stored condiment containers efficiently.

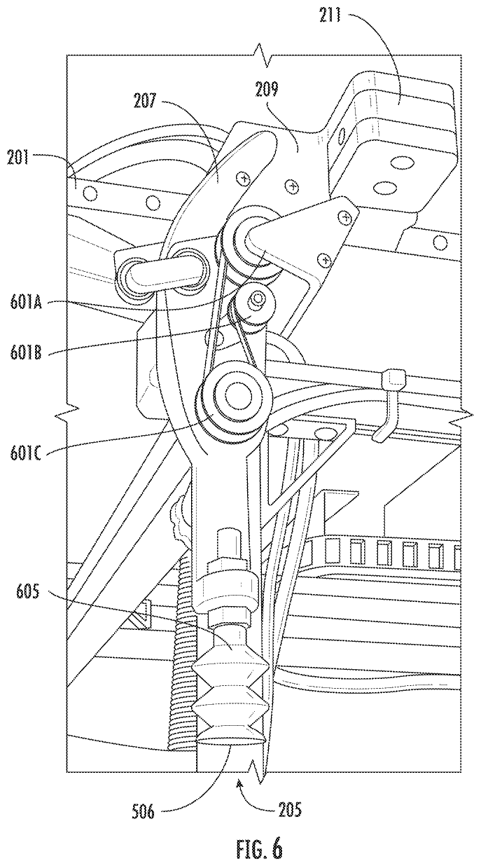

FIG. 6 illustrates a detailed view of the condiment gripper mechanism 203 in a lowered position. In some embodiments, in this configuration, the gripper arm 207 is extended downward, positioning the end effector 205 in close proximity to a condiment container 104 within a storage bin 102. In various embodiments, the lowered position may enable the end effector 205 to make contact with and secure a condiment container 104 for retrieval.

In some embodiments, the gripper arm 207 may include multiple articulation points, such as pivot joints 601A, 601B, and 601C. In various embodiments, these joints may allow for precise control and adjustment of the gripper arm's position and orientation. In some embodiments, in the lowered position, the pivot joints may be extended, creating a more elongated profile for the gripper mechanism.

In various embodiments, the end effector 205 in FIG. 6 may incorporate a suction cup 606 or similar gripping surface designed to securely hold condiment containers 104 of various sizes and shapes. In some embodiments, a vacuum channel 206 may run through the gripper arm 207, connecting the suction cup 606 to a vacuum source in the upper portion of the mechanism. In various embodiments, the configuration allows for the application of suction force to temporarily secure condiment containers 104 during retrieval and transport operations.

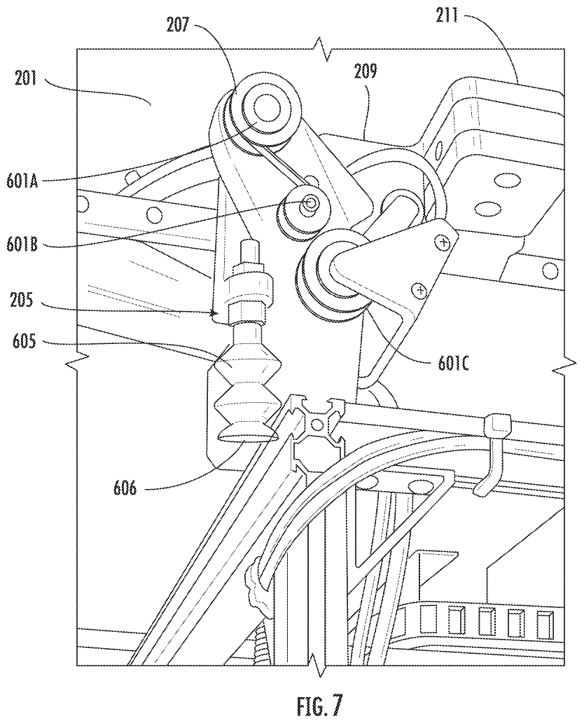

FIG. 7 depicts the condiment gripper mechanism 203 in a raised position. In various embodiments, in this configuration, the gripper arm 207 is retracted upward, bringing the end effector 205 closer to the movement mechanism 209. In some embodiments, the raised position may be utilized during horizontal translation of the gripper mechanism along the guide rail 201, allowing for unobstructed movement between storage bins 102.

In various embodiments, in the raised position, the pivot joints 601A, 601B, and 601C may be flexed or folded, creating a more compact profile for the gripper mechanism. In some embodiments, this compact configuration may reduce the overall vertical footprint of the condiment dispensing system 200 when not actively engaged in condiment retrieval, potentially minimizing interference with manual access to the storage bins 102.

In various embodiments, the transition between lowered and raised positions may be facilitated by the coordinated movement of the pivot joints and the flexibility provided by components such as the bellow 605. In some embodiments, this bellow may allow for expansion and contraction of the gripper arm while maintaining the integrity of the vacuum channel 206 throughout the range of motion.

In various embodiments, in both the lowered and raised positions, the vision sensor 211 mounted near the top of the assembly may continue to monitor the storage bins 102 and condiment containers 104. In some embodiments, the ongoing visual feedback may enable the condiment dispensing system 200 to make real-time adjustments to gripper positioning and to verify successful retrieval or release of condiment containers.

In various embodiments, the ability of the condiment gripper mechanism 203 to transition between lowered and raised positions may contribute to the overall efficiency and versatility of the condiment dispensing system 200. In some embodiments, the lowered position may allow for precise interaction between the end effector 205 and condiment containers 104, while the raised position may facilitate rapid movement between retrieval locations. In various embodiments, this dynamic range of motion may enable the condiment dispensing system 200 to adapt to various condiment storage configurations and to optimize its performance based on the specific requirements of each retrieval and dispensing operation.

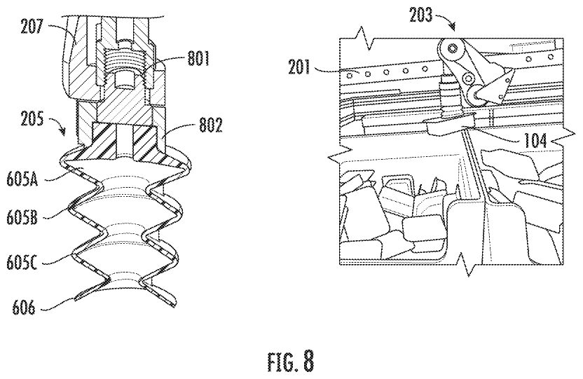

FIG. 8 illustrates a perspective view of an end effector 205 in accordance with some embodiments of the present disclosure. In various embodiments, the end effector may include a gripper arm 207 connected to a threaded connector 801. In some embodiments, a stabilizing collar 802 may be positioned below the threaded connector 801 to provide structural support and alignment for the end effector assembly.

In various embodiments, the end effector may incorporate a series of bellows arranged vertically. In some embodiments, these bellows may include a first bellow 605A, a second bellow 605B, and a lower bellow 605C. The bellows configuration may allow for flexibility and controlled compression during gripping operations. In various embodiments, a suction cup 606 may be located at the bottom of the bellows assembly for engaging with the condiment containers.

The bellows design may, in some embodiments, incorporate multiple collapsible sections that allow for controlled compression and extension during gripping operations. In various embodiments, this design may enable adaptive movement while maintaining suction capability through the assembly, potentially improving the ability of the condiment dispensing system 200 to handle condiment containers 104 of different sizes and shapes.

The vacuum force applied by the end effector 205 may serve multiple purposes in the condiment gripper system 200. For example, the vacuum force of the end effector 205 may be sufficiently strong to not only securely engage a condiment container 104, but also to compress the bellows tightly together to allow for rapid transport (e.g., reducing the overall length of the end effector 205 so as to reduce drag and avoid colliding with storage bins 102). When the vacuum force is released, the extended bellows may allow for greater flexibility to engage a condiment container surface at the angled orientation of the condiment container 104. This flexibility may be beneficial as condiment containers 104 within the storage bin 102 may be distributed at various angles, including tilted, upside down, and/or the like. Condiment containers 104 may shift, rotate, or stack in unpredictable ways due to factors such as restocking processes, vibrations from nearby equipment, or the natural settling of containers over time. By accommodating these varied orientations, the flexibility of the bellows enhances the ability of the condiment gripper system 200 to successfully retrieve containers regardless of their position, thereby improving overall operational efficiency and reducing the likelihood of failed pickup attempts. Furthermore, the flexibility offered by the extended bellows may enable the end effector 205 to make gentle contact with container surfaces, which minimizes the risk of damaging or puncturing the condiment containers during the dispensing process.

The ability to handle condiment containers 102 in multiple orientations also contributes to the versatility of the condiment gripper system 200 in managing different types of condiment packaging. Some condiments may come in squeeze bottles that naturally rest on their caps, while others may be in packets or pouches that lie flat. In various embodiments, the adaptive nature of the bellows-based end effector 205 enables the condiment gripper system 200 to efficiently handle the diversity of packaging types without requiring separate mechanisms or complex reprogramming for each container style.

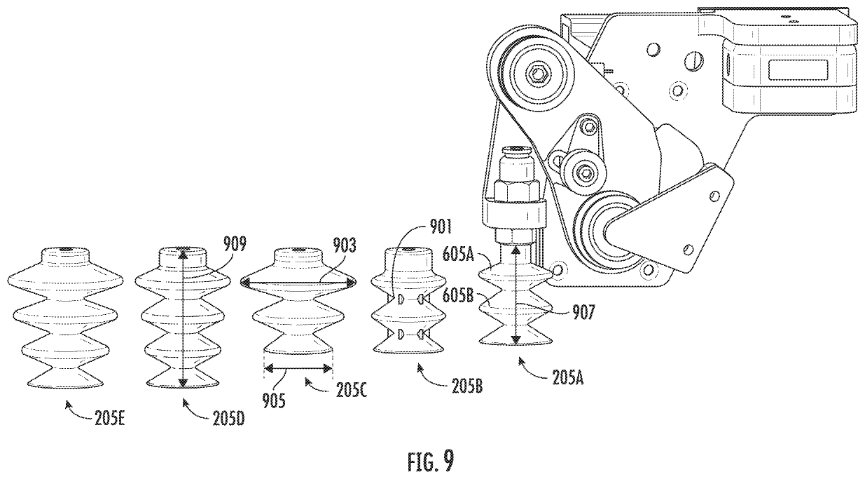

FIG. 9 illustrates a side-by-side comparison of different end effector configurations in accordance with some embodiments of the present disclosure. For example, depicted are multiple variations of bellows configurations designed for gripping condiment containers. In some embodiments, an end effector 205A may feature multiple bellows sections with a constant diameter throughout. Alternatively, in some embodiments, an end effector 205B may incorporate thicker walls compared to the end effector 205A and may include one or more ribs 901 between the bellows sections for additional structural support. In some embodiments, an end effector 205C may demonstrate a design with thicker walls than the end effector 205A and may incorporate a tapering conical shape. The bellows sections may vary between a first diameter 903 and a second diameter 905, potentially creating a graduated profile.

In various embodiments, an end effector 205D may maintain the same wall thickness as the end effector 205A but may feature a greater overall first length 907 and an increased number of bellows sections. The end effector 205D may include a first bellow 605A and a second bellow 605B as part of the extended structure. In some embodiments, an end effector 205E may combine elements from previous versions. The end effector 205E may maintain the wall thickness of the end effector 205A while incorporating greater overall length 909, increased number of bellows, and a tapering conical shape for the bellows sections.

The various end effector designs may, in some embodiments, represent different approaches to achieving improved grip functionality and preventing dropped condiment containers 104. In various embodiments, these design iterations may offer different combinations of flexibility, structural integrity, and adaptive gripping capabilities to suit various operational requirements of the condiment dispensing system.

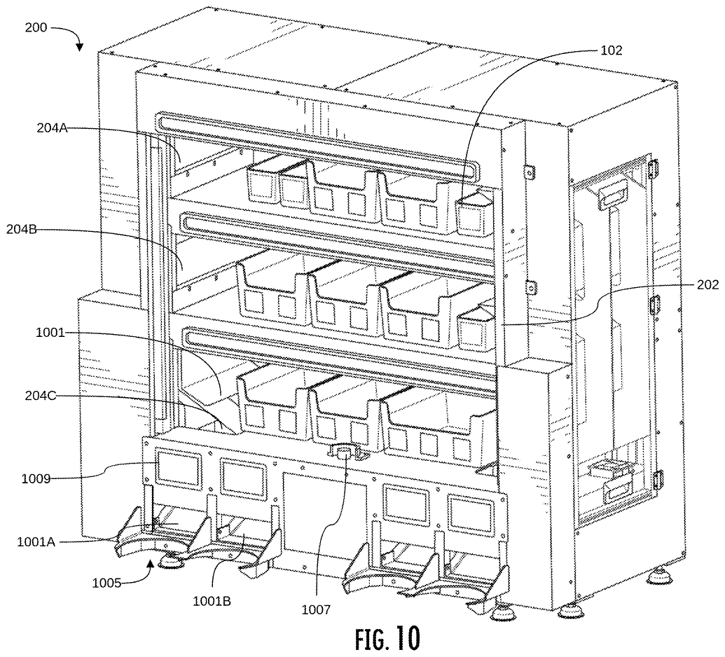

FIG. 10 illustrates a perspective view of the condiment dispensing system 200 in accordance with some embodiments of the present disclosure. In some embodiments, the condiment dispensing system 200 includes a frame 202 configured to support multiple rows of storage bins 102 arranged in a tiered configuration. In some embodiments, the condiment dispensing system 200 is configured to support both automated condiment retrieval operations via the condiment gripper mechanisms 203 and manual retrieval operations by team members, enabling the condiment dispensing system 200 to function as a collaborative robot, or cobot.

In some embodiments, the condiment dispensing system 200 includes multiple dispensing chutes arranged symmetrically on opposing sides of the frame 202. For example, in a configuration with three rows of storage bins 102, a first side of the condiment dispensing system 200 may include three dispensing chutes, with one dispensing chute positioned adjacent to each row of storage bins 102. In some embodiments, a second side of the condiment dispensing system 200 includes a corresponding arrangement of three dispensing chutes, with one dispensing chute positioned adjacent to each row of storage bins 102 on the opposing side. In some embodiments, this symmetrical arrangement enables condiment containers to be routed from either side of the condiment dispensing system 200, providing flexibility in directing dispensed condiments toward different output locations based on operational requirements.

In some embodiments, the condiment dispensing system 200 includes ramps configured to guide dispensed condiment containers along a controlled descent path. In some embodiments, ramp 1001 extends adjacent to the dispensing chutes 204A, 204B, and 204C, channeling condiment containers toward the lower portion of the condiment dispensing system 200. In some embodiments, ramps 1001A and 1001B direct condiment containers toward the accumulation zone 1005, where dispensed condiment containers gather for retrieval by team members during order fulfillment operations. In some embodiments, the respective slope angles of the ramps, slides, and/or the like are configured prevent condiment containers from becoming stuck or lodged during descent. In some embodiments, smooth transition features are incorporated at connection points between slides, ramps, or chutes to prevent certain packet sizes or shapes from becoming caught in gaps or seams. In various embodiments, by addressing these potential obstruction points, the condiment dispensing system 200 maintains reliable condiment flow from retrieval to collection.

In some embodiments, the accumulation zone 1005 provides a collection area at the bottom of the dispensing pathway where dispensed condiment containers gather for retrieval by team members. In some embodiments, a respective dispensing chute has an associated accumulation zone, enabling multiple condiment orders to be staged independently. In various embodiments, this arrangement supports parallel order fulfillment by allowing team members to collect condiments for one order while the condiment dispensing system 200 continues dispensing condiments for subsequent orders into separate accumulation zones.

In some embodiments, a removable bowl or receptacle is positioned at the accumulation zone 1005. In some embodiments, dispensed condiment containers flow into the removable bowl, and team members lift the bowl and transfer its contents into a bag, tray, or other container in a single action. In various embodiments, this approach consolidates what would otherwise be multiple individual retrieval actions into a single transfer operation, improving throughput during high-volume periods and reducing the handling time required for order assembly.

In various embodiments, the multi-chute configuration enables parallel fulfillment of multiple condiment orders simultaneously, which may improve throughput during high-volume periods. In some embodiments, in high-volume environments, fulfilling multiple condiment orders sequentially creates bottlenecks that reduce overall throughput. In various embodiments, by routing condiment containers to one of a plurality of dispensing chutes, the condiment dispensing system 200 enables concurrent order fulfillment without interference between orders destined for different collection areas.

In various embodiments, the dispensing chutes are configured to direct condiment containers to different accumulation zones or to a common accumulation zone. For example, dispensing chutes on a first side of the condiment dispensing system 200 may route to a first accumulation zone, while dispensing chutes on a second side may route to a second accumulation zone, enabling parallel order fulfillment at separate collection areas. In some embodiments, dispensing chutes on both sides converge to direct condiment containers to a single shared accumulation zone. In some embodiments, the condiment dispensing system 200 includes one or more routing mechanisms configured to selectively change which accumulation zone a dispensing chute outputs into. For example, such routing mechanisms may include movable deflectors, gates, or diverters that redirect condiment containers along different pathways based on order requirements, system status, or operator input. In various embodiments, this configurable routing capability enables dynamic allocation of dispensed condiments to different collection areas, further supporting parallel order fulfillment and reducing the likelihood of delays caused by sequential processing of condiment orders.

In some embodiments, the condiment dispensing system 200 includes a suspension control 1007 configured to provide operational control functionality for pausing and resuming automated dispensing operations. In some embodiments, team members activate the suspension control 1007 to pause automated operations when manual intervention is needed, such as for custom orders, last-minute condiment requests, or system maintenance. In some embodiments, upon resuming, the condiment dispensing system 200 continues automated operations from where it left off. In various embodiments, this suspension and resumption capability supports the collaborative robot (cobot) functionality of the condiment dispensing system 200, enabling seamless transitions between automated and manual dispensing as operational needs dictate.

In some embodiments, displays 1009 provide visual information regarding condiment dispensing operations, order tracking, and system notifications. In some embodiments, team members monitor the status of condiment orders, view system alerts, and receive guidance on replenishment needs via the displays 1009. In various embodiments, the displays 1009 support coordination between automated dispensing and manual order assembly activities, helping team members maintain awareness of system status and pending orders. In various embodiments, the configuration of the condiment dispensing system 200 shown in FIG. 10 demonstrates how the integration of multiple dispensing chutes, accumulation zones, removable collection receptacles, suspension controls, and displays supports high-throughput condiment dispensing while maintaining flexibility for manual intervention, enabling QSR operators to scale condiment dispensing operations to meet peak demand while preserving the cobot functionality that allows team members to collaborate with the automated system.

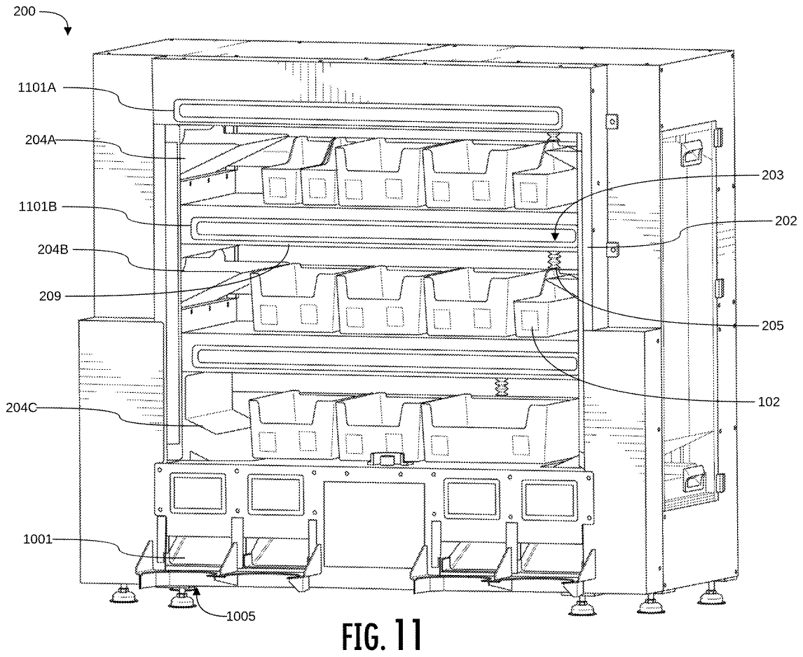

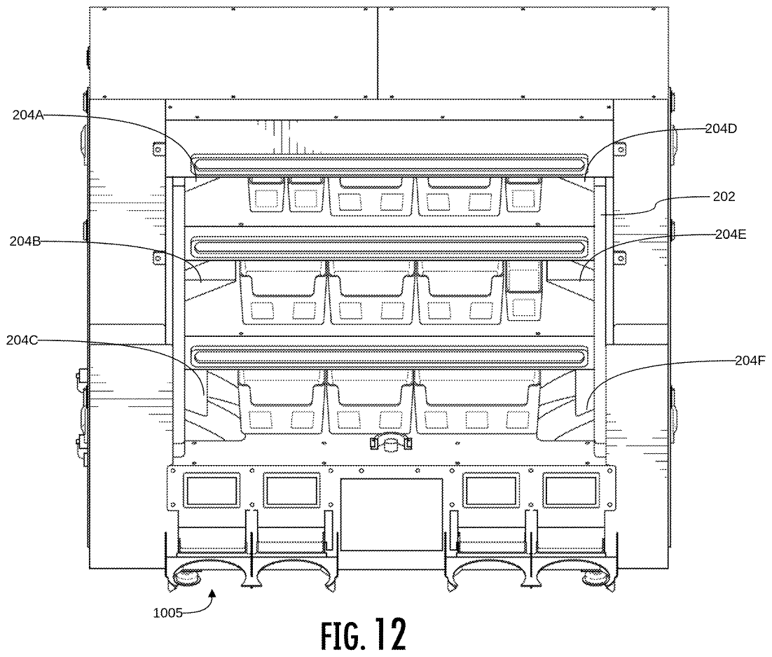

FIGS. 11 and 12 illustrate front perspective and front views of the condiment dispensing system 200 in accordance with some embodiments of the present disclosure. In some embodiments, the condiment dispensing system 200 includes a frame 202 configured to support multiple rows of storage bins 102, one or more condiment gripper mechanisms 203 positioned along guide rails 201, and multiple dispensing chutes arranged on opposing sides of the frame 202. In some embodiments, the condiment dispensing system 200 incorporates a six-chute configuration comprising dispensing chutes 204A, 204B, 204C, 204D, 204E, and 204F, enabling high-throughput parallel order fulfillment across multiple rows and sides of the system.

In some embodiments, the condiment dispensing system 200 includes dispensing chutes 204A, 204B, and 204C positioned along one side of the frame 202, with dispensing chutes 204D, 204E, and 204F positioned along an opposing side of the frame 202. In some embodiments, a respective dispensing chute is associated with a respective row of storage bins 102. In various embodiments, the independent routing pathways enable condiment containers retrieved from different rows to be directed to separate collection points without interference between dispensing operations. In various embodiments, this configuration eliminates sequential processing bottlenecks by enabling true parallel dispensing across multiple rows and sides of the condiment dispensing system 200. In some embodiments, in high-volume environments, the ability to route condiments independently through multiple pathways substantially increases throughput compared to systems that rely on a single dispensing pathway or sequential processing of condiment orders.

In some embodiments, for a single order requiring multiple condiment types stored across different rows of storage bins 102, the condiment dispensing system 200 coordinates multiple condiment gripper mechanisms 203 to retrieve condiments concurrently. In some embodiments, retrieved condiments route through respective dispensing chutes to a designated accumulation zone. For example, an order requiring ketchup stored in row 103A, barbecue sauce stored in row 103B, and sweet and sour sauce stored in row 103C may be fulfilled by three condiment gripper mechanisms operating simultaneously, with the retrieved condiments converging at a single accumulation zone. In various embodiments, this concurrent retrieval approach reduces order fulfillment time compared to sequential retrieval methods, in which a single condiment gripper mechanism would need to traverse between rows to collect each condiment type individually. In some embodiments, the reduction in fulfillment time is particularly pronounced for orders requiring condiments from multiple rows, as the condiment gripper mechanisms operate in parallel rather than in sequence.

In some embodiments, the condiment dispensing system 200 supports concurrent fulfillment of multiple independent orders by routing condiments to different accumulation zones. For example, a first order may route to a left-side accumulation zone via dispensing chutes 204A, 204B, and 204C, while a second order may route to a right-side accumulation zone via dispensing chutes 204D, 204E, and 204F. In some embodiments, condiment gripper mechanisms on each side of the condiment dispensing system 200 operate independently, enabling overlapping retrieval and dispensing cycles for the respective orders. In various embodiments, this independent operation enables throughput to scale with order volume without proportional increases in fulfillment time. In some embodiments, in high-volume periods, the condiment dispensing system 200 processes multiple orders simultaneously, with each order being fulfilled through a dedicated subset of dispensing chutes and accumulation zones, thereby reducing wait times and increasing overall operational efficiency.

In some embodiments, visual indicators 1101A and 1101B are positioned proximate to dispensing chutes 204A and 204B, respectively. In some embodiments, the visual indicators signal operational status information related to the dispensing chutes and associated accumulation zones. For example, a visual indicator may signal when a dispensing chute is active, when condiments are in transit through the chute, or when an accumulation zone is ready for pickup by a team member. In some embodiments, the visual indicators display different colors or patterns to indicate order progress, such as a first color or pattern indicating that an order is in-progress, a second color or pattern indicating that an order is complete, and a third color or pattern indicating that condiments are awaiting pickup. In various embodiments, this visual signaling enables team members to monitor the status of multiple orders without requiring direct observation of the dispensing process, thereby allowing team members to focus on other order assembly tasks while remaining aware of when condiments are ready for collection.

In some embodiments, the visual indicators also signal fill levels within the storage bins 102. In some embodiments, the condiment dispensing system 200 determines fill levels via one or more sensing mechanisms, such as depth-sensing cameras, weight sensors, retrieval count tracking, and/or the like. For example, a depth-sensing camera may scan across the storage bins 102 to assess the volume of condiment containers remaining in each bin. In some embodiments, weight sensors monitor the weight of each storage bin to estimate fill levels based on the known weight of individual condiment containers. In some embodiments, retrieval count tracking monitors the number of condiments retrieved from each bin and compares the count to a known initial quantity to estimate remaining inventory. In some embodiments, the visual indicators display graduated colors to signal fill levels, such as a first color (e.g., green) when a storage bin is full or near full, a second color (e.g., yellow) when a storage bin is at a medium fill level, and a third color (e.g., red) when a storage bin is at or below a threshold fill level. In various embodiments, this visual signaling enables proactive replenishment before stockouts occur, reducing the likelihood of service interruptions caused by depleted condiment supplies.

In some embodiments, the condiment dispensing system 200 incorporates predictive inventory capabilities to forecast replenishment needs. In some embodiments, the system tracks condiment retrieval rates over time, monitoring how frequently each condiment type is dispensed during different periods of operation. In some embodiments, historical data regarding retrieval rates is combined with real-time order information to predict when specific condiment types may be depleted. For example, the condiment dispensing system 200 may determine that ranch dressing is typically retrieved at a rate of 20 containers per hour during lunch periods. In some embodiments, if the current inventory of ranch dressing is 50 containers and the lunch rush has begun, the system predicts that the ranch dressing supply will be depleted within approximately 2.5 hours. In some embodiments, the system generates alerts or notifications via displays 1009 when predicted depletion approaches, such as when the predicted time to depletion falls below a threshold (e.g., 15 minutes). In various embodiments, this predictive approach shifts inventory management from a reactive model, in which replenishment occurs only after stockouts are observed, to a proactive model, in which replenishment occurs in anticipation of future needs. In various embodiments, the proactive approach reduces stockout occurrences and improves service continuity during high-volume periods.

In some embodiments, the condiment dispensing system 200 is designed to operate collaboratively with human team members, functioning as a collaborative robot, or cobot. In some embodiments, team members manually retrieve condiments from the storage bins 102 while automated operations continue on other bins. In some embodiments, the suspension control 1007 enables team members to pause and resume automated operations as needed, such as when manual intervention is required for custom orders, last-minute condiment requests, or system maintenance. In some embodiments, the condiment dispensing system 200 detects manual interaction, such as when a team member places a hand into a storage bin, and automatically pauses automated operations for that specific bin. In some embodiments, upon detecting that the manual interaction has ceased, such as when the team member removes their hand from the storage bin, the system automatically resumes automated operations for the affected bin. In various embodiments, this automatic pause-and-resume functionality preserves manual access flexibility while maintaining automated throughput for unaffected bins. In various embodiments, the cobot functionality enables the condiment dispensing system 200 to adapt to varying operational needs, supporting both fully automated dispensing during high-volume periods and manual intervention when customization or human judgment is required.

In some embodiments, the condiment dispensing system 200 incorporates edge case handling capabilities to address operational scenarios that deviate from standard dispensing workflows. In some embodiments, one such edge case involves an accumulation zone reaching or approaching capacity. In some embodiments, the condiment dispensing system 200 monitors accumulation zone capacity via one or more sensors, such as optical sensors, weight sensors, or retrieval tracking mechanisms that count the number of condiments dispensed to each accumulation zone. In some embodiments, when an accumulation zone approaches capacity, the condiment dispensing system 200 pauses dispensing operations to that zone, redirects subsequent condiments to an alternate accumulation zone, or signals team members via visual indicators or displays 1009 to collect the accumulated condiments. In various embodiments, by preventing overflow, the condiment dispensing system 200 avoids spillage, condiment damage, or confusion regarding which condiments belong to which order. In various embodiments, this edge case handling maintains orderly collection even during high-volume periods when multiple orders may be processed in rapid succession.

In some embodiments, the condiment dispensing system 200 detects and responds to condiment obstructions or jams within the dispensing chutes or ramps. In some embodiments, the condiment dispensing system 200 detects obstructions via sensors positioned along the dispensing chutes or ramps, or by monitoring expected transit times for condiments traveling from the condiment gripper mechanism 203 to the accumulation zone. For example, if a condiment container is released into a dispensing chute but does not arrive at the accumulation zone within an expected time window, the condiment dispensing system 200 may infer that an obstruction has occurred. In some embodiments, upon detecting a potential jam, the condiment dispensing system 200 pauses dispensing operations to the affected pathway, alerts team members via a visual indicator or display notification, and continues operations on unaffected pathways. In various embodiments, this isolated response minimizes the impact of a single pathway failure on overall system throughput. In some embodiments, team members then address the obstruction, such as by manually clearing the jammed condiment, and resume operations on the affected pathway once the obstruction is resolved.

In some embodiments, the condiment dispensing system 200 handles order modifications or cancellations that occur during the fulfillment process. In some embodiments, the system receives updated order information from a kitchen production system (KPS) or other order management system. In some embodiments, if an order is modified, such as when a customer requests an additional condiment type or removes a previously requested condiment, the condiment dispensing system 200 adjusts its dispensing operations accordingly. For example, if a condiment is added to an order that is already in progress, the system may queue the additional condiment for retrieval and dispensing. In some embodiments, if a condiment is removed from an order, the system cancels the retrieval operation if it has not yet begun, or flags the condiment for manual return to the storage bin if it has already been dispensed. In some embodiments, in the case of a complete order cancellation, condiments that have already been dispensed to an accumulation zone are flagged for manual return or reallocation to a different order. In various embodiments, this dynamic adjustment capability maintains order accuracy despite late-stage changes, reducing waste and ensuring that customers receive the condiments they have requested.

In some embodiments, the condiment dispensing system 200 coordinates mixed automated and manual fulfillment for orders that require both types of retrieval. For example, an order may include standard condiments that are readily dispensed by the automated system, as well as specialty condiments or items that require manual retrieval by a team member. In some embodiments, the displays 1009 indicate which condiments are being fulfilled automatically and which require manual retrieval, enabling team members to coordinate their actions with the automated system. In some embodiments, the condiment dispensing system 200 delays automated dispensing until a team member signals readiness to receive the condiments, or conversely, the system completes automated dispensing and signals the team member to add the manually retrieved items. In various embodiments, this coordination optimizes the workflow for complex orders, ensuring that all condiments are collected and assembled efficiently without requiring team members to wait for automated dispensing to complete or vice versa.

In some embodiments, the displays 1009 provide comprehensive operational information to support team member awareness and decision-making. In some embodiments, the displays present information regarding the order queue, showing which orders are pending fulfillment and the condiment requirements for each order. In some embodiments, fulfillment progress information indicates which condiments have been retrieved, which are currently in transit, and which are awaiting pickup at accumulation zones. In some embodiments, system alerts notify team members of conditions requiring attention, such as low inventory levels, detected obstructions, or system maintenance needs. In some embodiments, inventory status information shows current fill levels for each storage bin, predicted depletion times, and replenishment recommendations. In some embodiments, team members interact with the displays 1009 to view pending orders, acknowledge alerts, adjust system settings, or manually trigger dispensing operations. In some embodiments, the displays integrate with a kitchen production system (KPS) to receive real-time order information and condiment requirements, ensuring that the condiment dispensing system 200 remains synchronized with overall order fulfillment workflows. In various embodiments, this centralized operational awareness reduces the need for team members to monitor multiple information sources, streamlining coordination between automated dispensing and manual order assembly activities.

In some embodiments, the condiment dispensing system 200 includes ramps configured to guide dispensed condiment containers along a descent path toward one or more accumulation zones. In some embodiments, ramp 1003 is positioned at a lower portion of the condiment dispensing system 200 and guides dispensed condiments along a controlled descent path toward the accumulation zone 1005. In some embodiments, ramps 1001A and 1001B provide additional routing pathways for directing condiments from the dispensing chutes to the accumulation zones. In some embodiments, the angles of the ramps and the incorporation of smooth transitions at connection points maintain reliable condiment flow across varying packet sizes and shapes. For example, smaller condiment packets, such as individual sauce containers, may travel along the ramps at different speeds or trajectories compared to larger packets, such as squeeze bottles. In various embodiments, the ramp configuration accommodates this variability, ensuring consistent condiment delivery regardless of container type. In various embodiments, this design consideration reduces the likelihood of condiments becoming stuck or lodged during descent, maintaining continuous operation and minimizing the need for manual intervention to clear obstructions.

In various embodiments, the configuration of the condiment dispensing system 200 shown in FIGS. 10-12 demonstrates the integration of multiple dispensing chutes, visual indicators, displays, suspension controls, and accumulation zones to support high-throughput condiment dispensing operations. In various embodiments, the system balances automated dispensing capabilities with flexibility for manual intervention and edge case handling, enabling operations to scale from low-volume periods to peak demand while maintaining order accuracy and fulfillment speed. In various embodiments, the incorporation of predictive inventory management, real-time status signaling, and coordinated human-system interaction provides a comprehensive condiment dispensing solution adaptable to varying QSR operational requirements. In various embodiments, by addressing challenges related to parallel order fulfillment, inventory management, system reliability, and human-robot collaboration, the condiment dispensing system 200 enhances operational efficiency and customer satisfaction in quick-service restaurant environments.

In some embodiments, the condiment dispensing system 200 implements a plurality of heuristic rules to govern automated dispensing operations. In some embodiments, these heuristic rules define operational logic for scenarios such as when to engage or disengage automated dispensing, how to prioritize condiment retrieval across multiple orders, when to route items to manual fulfillment, and how to respond to detected edge cases. In various embodiments, certain heuristic rules address capacity management and safety considerations during dispensing operations. For example, a first rule may specify that when an accumulation zone reaches a threshold capacity, subsequent condiments for that zone are routed to an alternate accumulation zone or assigned to manual fulfillment. As another example, a second rule may specify that when a team member is detected in proximity to a storage bin, the condiment gripper mechanism 203 associated with that bin pauses operations. As another example, a third rule may govern the sequencing of retrieval operations across multiple condiment gripper mechanisms 203 to prevent collisions or interference along shared pathways.

In addition or as an alternative to capacity and safety rules, other heuristic rules may be implemented to govern the selective engagement of automated dispensing based on order characteristics. For example, a fourth rule may specify that the condiment dispensing system 200 engages automated dispensing only when an order meets or exceeds a threshold quantity of condiment containers or a threshold diversity of condiment types. For orders below the threshold, such as orders requiring only one or two condiment containers, the condiment dispensing system 200 may remain inactive and defer to manual retrieval by team members, which may be more time efficient for simpler orders. As another example, a fifth rule may adjust the priority sequence of pending orders based on order size and timing. For example, when a large order with a significant number of condiment containers is followed by a smaller order, the condiment dispensing system 200 may elevate the priority of the smaller order to prevent excessive wait times, or may route the smaller order to manual fulfillment while the automated system processes the larger order.

Further heuristic rules address dynamic operational conditions and workflow coordination between automated and manual fulfillment. For example, a sixth rule may monitor whether dispensed condiments are collected from the accumulation zone within an expected time window. If condiments remain uncollected beyond the expected window, the condiment dispensing system 200 may infer that a team member has moved on without collecting the condiments and may reassign remaining items in that order to manual fulfillment rather than continuing to dispense condiments that would sit uncollected. As another example, a seventh rule may detect sudden increases in order volume, such as when a large catering order is received or when a bus arrives at the restaurant, and may adjust the balance between automated and manual dispensing accordingly. For example, the condiment dispensing system 200 may increase the proportion of orders routed to automated fulfillment, may activate additional condiment gripper mechanisms 203, or may preemptively trigger replenishment alerts for condiment types predicted to be in high demand. In various embodiments, these heuristic rules are configurable and adjustable based on restaurant-specific preferences, operational conditions, and/or the like.

In some embodiments, two or more heuristic rules produce conflicting directives in certain operational scenarios. For example, a first rule may direct the condiment dispensing system 200 to continue automated dispensing to meet an order fulfillment time target, while a second rule may direct the condiment dispensing system 200 to pause dispensing because an accumulation zone is approaching capacity. In various embodiments, when such conflicts arise, the condiment dispensing system 200 requires an additional decision-making layer to resolve the conflict and determine which rule to prioritize.

In some embodiments, the condiment dispensing system 200 incorporates a machine learning model to resolve conflicts between competing heuristic rules. In some embodiments, the machine learning model comprises a neural network, a large language model (LLM), a reinforcement learning model, and/or the like. For example, a reinforcement learning model may be trained using a reward-based framework in which the model receives a positive reward when orders are fulfilled within a target time threshold (e.g., 2.5 minutes, or another suitable reward value) and a negative reward when the target is exceeded. As another example, the model may receive a positive reward when order feedback indicates the requested condiments were accurately dispensed, and the model may receive a negative reward when order feedback indicates incorrect or incomplete fulfilment of requested condiments. As another example, the model may receive a positive reward when condiment containers are successfully delivered to the correct accumulation zone without obstruction, and a negative reward when a condiment container becomes jammed in a dispensing chute or is delivered to an incorrect accumulation zone. As another example, the model may receive a positive reward when a team member collects dispensed condiments from an accumulation zone within an expected time window, and a negative reward when dispensed condiments remain uncollected beyond the expected window. As another example, the model may receive a positive reward when condiment inventory levels remain above a minimum threshold throughout a service period, and a negative reward when a stockout occurs for a condiment type during active order fulfillment. In various embodiments, over time, the model learns to select the appropriate rule or combination of rules that optimizes order fulfillment performance under varying operational conditions. In some embodiments, the machine learning model operates as a local model deployed on the condiment dispensing system 200, enabling real-time decision-making without reliance on external computing resources.

In some embodiments, the reward function is generated based on a combination of weighted attributes. In some embodiments, the attributes include order fulfillment time, accumulation zone utilization, condiment delivery success rate, team member collection latency, inventory depletion rate, order accuracy, system throughput, condiment container damage rate, and/or the like. In some embodiments, a respective attribute is assigned a respective weight reflecting its relative importance to overall system performance. For example, order fulfillment time may be assigned a higher weight than inventory depletion rate during peak service periods, while inventory depletion rate may be assigned a higher weight during pre-rush preparation periods. In various embodiments, the weights are configurable and adjustable based on restaurant-specific priorities, time of day, current operational conditions, and/or the like. In some embodiments, the reward function computes a composite score by combining the weighted attributes, and the reinforcement learning model optimizes its rule selection to maximize the composite score over time.

In some embodiments, the machine learning model is trained using operational data collected from the condiment dispensing system 200 across a plurality of operational conditions. In some embodiments, the operational data includes order volumes, retrieval times, accumulation zone fill levels, team member interaction patterns, condiment type distributions, and/or the like. In some embodiments, the plurality of operational conditions includes normal operating conditions, peak conditions with excess order volumes, conditions with diverse orders comprising a wide variety of condiment types, conditions associated with catering orders or large batch fulfillment requests, low-staffing conditions, and/or the like. In various embodiments, training the machine learning model across this plurality of operational conditions enables the model to generalize its decision-making across a broader range of scenarios than would be achievable through training on normal operating conditions alone. In some embodiments, the machine learning model is trained in a federated manner across a plurality of condiment dispensing systems deployed at different QSR locations. In various embodiments, in federated training, a respective condiment dispensing system trains a local instance of the machine learning model using locally collected operational data, and model updates from the plurality of condiment dispensing systems are aggregated to improve the global model without requiring the transfer of raw operational data between locations. In various embodiments, this federated approach enables the machine learning model to learn from diverse operational conditions across multiple QSR environments while preserving data privacy for individual locations.

In some embodiments, the machine learning model evaluates current operational conditions, including pending order data, current accumulation zone fill levels, team member positions, condiment inventory levels, and historical performance data, to determine which heuristic rule or combination of rules to apply in a given scenario. In various embodiments, this adaptive decision-making capability enables the condiment dispensing system 200 to optimize its operations in real-time, adapting to dynamic restaurant environments where order volumes, team member availability, and condiment demand fluctuate throughout the day.

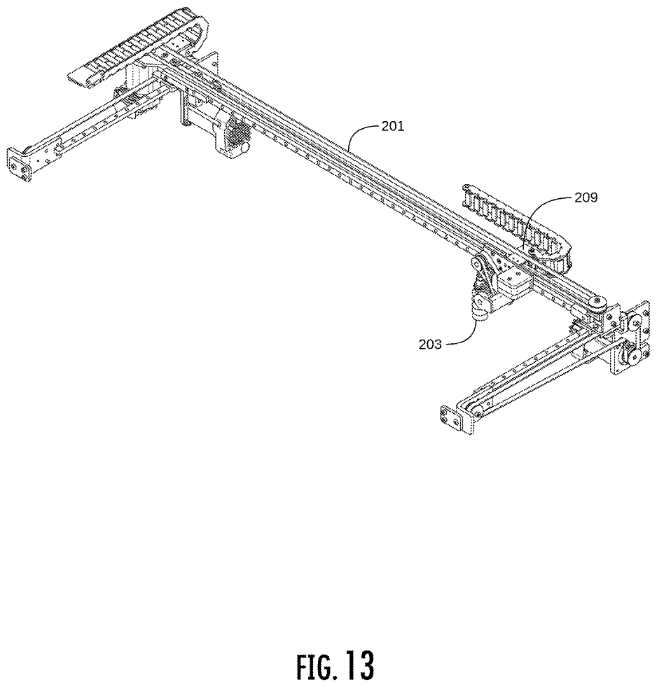

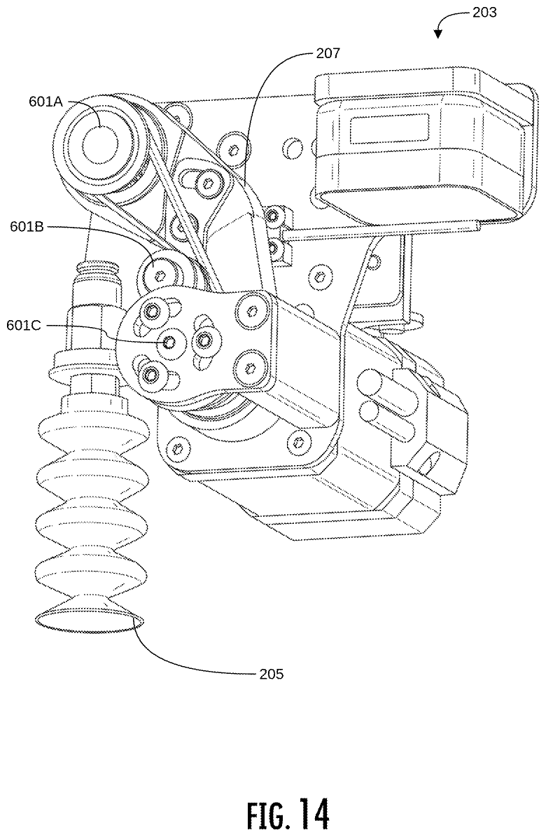

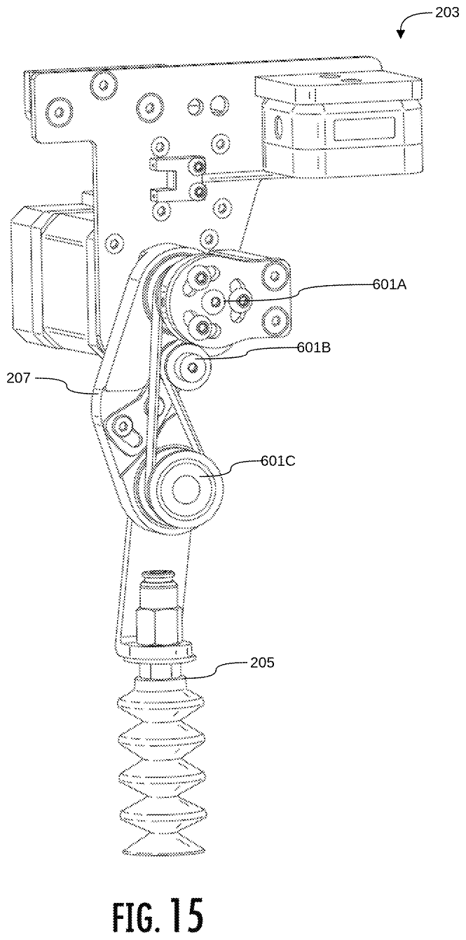

FIGS. 13, 14, and 15 illustrate various views of the condiment gripper mechanism 203 in accordance with some embodiments of the present disclosure. In some embodiments, FIG. 13 depicts a perspective view of the condiment gripper mechanism 203 mounted to the guide rail 201 via the movement mechanism 209, FIG. 14 depicts the condiment gripper mechanism 203 in a lowered position, and FIG. 15 depicts a close-up view of the drive mechanism and the end effector 205. In some embodiments, the guide rail 201 extends horizontally across the assembly, providing a track along which the condiment gripper mechanism 203 translates. In some embodiments, the movement mechanism 209 is positioned along the guide rail 201 and is configured to engage with the guide rail 201 to enable horizontal translation of the condiment gripper mechanism 203 across the condiment service area 101. In some embodiments, cable management chains are positioned at opposing ends of the guide rail 201 and are configured to route cables and other connections along the length of the guide rail 201 as the condiment gripper mechanism 203 translates horizontally. In various embodiments, this cable management configuration maintains organized routing of power and signal connections throughout the range of motion of the condiment gripper mechanism 203.

In some embodiments, the gripper arm 207 extends from the movement mechanism 209 and is configured to support the end effector 205 for condiment retrieval operations. In some embodiments, the gripper arm 207 includes multiple articulation points comprising pivot joint 601A, pivot joint 601B, and pivot joint 601C. In various embodiments, the pivot joints 601A, 601B, and 601C allow for precise control and adjustment of the position and orientation of the gripper arm 207 during condiment retrieval and dispensing operations. In some embodiments, as shown in FIG. 14, in a lowered position, the pivot joints 601A, 601B, and 601C are extended, creating an elongated profile that enables the end effector 205 to reach into storage bins 102 of varying depths to contact condiment containers 104 stored therein. In some embodiments, in a raised position, the pivot joints 601A, 601B, and 601C are flexed, creating a compact profile that provides clearance for horizontal translation along the guide rail 201 without interference with the storage bins 102 or team members operating in the condiment service area 101. In some embodiments, as shown in FIG. 15, a belt-and-pulley drive arrangement connects pivot joint 601A to pivot joint 601B, providing rotational force transfer between the articulation points to facilitate controlled movement of the gripper arm 207. In some embodiments, a motor or drive component is mounted to an upper portion of the gripper arm 207 and provides motive force for articulating the pivot joints 601A, 601B, and 601C.

In some embodiments, the end effector 205 extends downward from the gripper arm 207 and includes a bellows configuration with multiple collapsible sections terminating in a suction cup at the lower end. In various embodiments, the collapsible sections of the bellows compress when a vacuum force is applied, reducing the overall length of the end effector 205 for transport, and extend when the vacuum force is released, providing flexibility for engaging condiment containers 104 at various orientations within the storage bins 102. In some embodiments, the bellows structure provides compliance to accommodate condiment containers 104 that are tilted, stacked, or otherwise positioned at non-uniform angles. In some embodiments, the suction cup at the lower end of the end effector 205 provides the contact surface for securing condiment containers 104 via the vacuum force. In various embodiments, the combination of the bellows configuration and the suction cup enables the end effector 205 to accommodate condiment containers 104 of varying sizes, shapes, and surface textures.

In some embodiments, the at least one controller coordinates the operation of the condiment gripper mechanism 203 to perform a condiment retrieval and dispensing sequence. For example, the at least one controller may receive order data from a kitchen production system (KPS) defining at least one condiment type and at least one condiment quantity. In some embodiments, the at least one controller activates the movement mechanism 209 to translate the condiment gripper mechanism 203 along the guide rail 201 to a position aligned with a target storage bin 102 containing the requested condiment type. In some embodiments, the vision sensor 211 captures image data to identify and locate a target condiment container 104 within the storage bin 102. In some embodiments, the at least one controller coordinates the pivot joints 601A, 601B, and 601C to lower the end effector 205 into the storage bin 102 and activates the vacuum force to secure the condiment container 104. In some embodiments, the at least one controller then coordinates the pivot joints to retract the gripper arm 207 to a raised position while maintaining the vacuum force on the condiment container 104 to prevent inadvertent release during transport. In some embodiments, the at least one controller translates the condiment gripper mechanism 203 to a position aligned with a designated dispensing chute 204, where the vacuum force is deactivated to release the condiment container 104 into the dispensing chute 204 for conveyance to a corresponding accumulation zone 1005.

In various embodiments, this coordinated sequence of lowering, securing, raising, and translating enables efficient condiment retrieval with minimal cycle time between successive retrieval operations. In some embodiments, the precise control of pivot joint articulation via the belt-and-pulley drive arrangement enables the condiment gripper mechanism 203 to adapt its retrieval approach based on the depth and orientation of a target condiment container 104 within a storage bin 102. In various embodiments, the integration of the belt-and-pulley drive arrangement, the pivot joints 601A, 601B, and 601C, and the bellows-based end effector 205 provides the condiment gripper mechanism 203 with the mechanical versatility to reliably retrieve condiment containers 104 across a range of storage configurations and container orientations.

In various embodiments, the condiment dispensing system 200 enhances the efficiency and accuracy of condiment dispensing operations in QSR environments. By automating the retrieval and dispensing of condiment containers, the condiment dispensing system 200 may reduce the time and labor required for manual handling, potentially increasing overall order fulfillment speed. The adaptive nature of the gripper mechanism, with its ability to handle various condiment container sizes and shapes, may improve versatility compared to existing manual approaches. Additionally, the integration of the condiment dispensing system 200 with existing storage infrastructure may allow for seamless implementation without major renovations. The incorporation of safety features and the option for manual override may provide flexibility in operations, adapting to varying customer demands and operational needs. Furthermore, the precision and consistency offered by the automated system may lead to improved inventory management and reduced waste. The condiment dispensing system may enhance customer satisfaction through faster service and more accurate order fulfillment while optimizing resource utilization for restaurant operators.

In some embodiments, the condiment dispensing system 200 incorporates software features that enhance operational continuity and workflow coordination. One challenge in automated dispensing environments is maintaining seamless operation when human workers interact with the system. When a team member reaches into a storage bin to manually retrieve a condiment, the system may pause automated operations for safety reasons. Without thoughtful design, such pauses could require manual re-engagement through a console, touchscreen, or other input device, creating workflow interruptions. To address this challenge, the condiment dispensing system 200 may be configured to automatically resume automated operations upon detecting that manual interaction has ceased, such as when a team member removes their hand from a storage bin. This automatic resumption reduces the need for explicit system re-engagement, thereby maintaining operational efficiency and minimizing disruptions to the dispensing workflow. In some embodiments, the condiment dispensing system 200 incorporates intelligent task routing or orchestration capabilities to dynamically allocate dispensing tasks between automated and manual fulfillment. Coordinating automated and manual operations presents challenges, particularly when timing mismatches occur between automated dispensing and order assembly. For example, if a collection area becomes full or a team member is occupied with other tasks, automatically dispensed condiments may sit uncollected, potentially causing confusion or delays. The condiment dispensing system 200 may address this by predicting when a team member is likely to manually retrieve a condiment and preemptively routing one or more remaining condiment items to manual fulfillment. This predictive routing optimizes the coordination between automated and manual operations, reducing delays and improving overall workflow efficiency.

In some embodiments, the condiment dispensing system 200 incorporates hardware features that streamline the collection and transfer of dispensed condiments. Efficiently gathering multiple dispensed items presents a challenge in automated systems, as team members may otherwise need to individually grasp each condiment container from a collection area, which increases handling time and reduces throughput. A removable receptacle approach addresses this challenge by allowing dispensed condiment containers to flow into a bowl or similar container positioned at a collection area. Team members lift the removable bowl and transfer its contents into a bag, tray, or other container in a single action, reducing the number of handling steps required during order assembly. This approach may improve throughput during high-volume periods by consolidating what would otherwise be multiple retrieval actions into a single transfer operation. In some embodiments, the condiment dispensing system 200 includes one or more ramps, slides, or chutes configured to guide dispensed condiment containers from the storage bins to a collection area. Guiding condiment containers along a descent path introduces considerations related to container movement and potential obstructions. Condiment containers of varying sizes and shapes may behave differently as they travel along slides or ramps, and certain packet dimensions may be prone to becoming stuck or lodged at particular points. The angle of a final slide or ramp may be adjusted to prevent condiment containers from becoming stuck or lodged during descent. In some embodiments, smooth transition features are incorporated at connection points between slides, ramps, or chutes to prevent certain packet sizes or shapes from becoming caught in gaps or seams. By addressing these potential obstruction points, the condiment dispensing system 200 maintains reliable condiment flow from retrieval to collection.

In some embodiments, the condiment dispensing system 200 includes multiple dispensing chutes configured to route condiment containers to different collection areas or order fulfillment stations. In high-volume environments, fulfilling multiple condiment orders sequentially may create bottlenecks that reduce overall throughput. By routing condiment containers to one of a plurality of chutes, the condiment dispensing system 200 enables parallel fulfillment of multiple condiment orders simultaneously. In some embodiments, slides or ramps on one side of the condiment dispensing system 200 route to a first subset of chutes, while slides or ramps on an opposing side route to a second subset of chutes. This multi-chute configuration increases throughput by allowing multiple orders to be fulfilled concurrently without interference, addressing the challenge of scaling condiment dispensing operations to meet peak demand. In some embodiments, the condiment gripper mechanism 203 is configured to drop retrieved condiment containers to the side of a storage bin rather than off the back of the storage bin. The positioning of the drop location affects the overall system layout and integration with existing infrastructure. A side-drop configuration may simplify the routing of condiment containers to dispensing chutes by reducing the path complexity, reduce the overall depth of the condiment dispensing system 200 to accommodate space-constrained environments, and facilitate integration with existing condiment storage arrangements that may have limited clearance behind the storage bins.

In some embodiments, the condiment dispensing system 200 incorporates inventory monitoring and signaling features to assist team members with condiment replenishment. In some embodiments, maintaining adequate condiment levels supports uninterrupted dispensing operations, yet monitoring fill levels across multiple storage bins presents challenges, particularly during busy periods when team members are focused on order fulfillment. The condiment dispensing system 200 may include one or more depth-sensing cameras or sensors configured to detect fill levels within the storage bins 102. In some embodiments, the depth-sensing camera scans across the storage bins at startup or periodically during operation to map bin configurations and assess condiment levels. The condiment dispensing system 200 may include visual indicators, such as multi-color LED strips, positioned proximately to each storage bin or row of storage bins. In some embodiments, the visual indicators display different colors to signal fill levels, such as a first color (e.g., green) when a storage bin is full or near full, a second color (e.g., yellow) when a storage bin is at a medium fill level, and a third color (e.g., red) when a storage bin is at or below a threshold fill level, such as the last 10% of capacity. This visual signaling alerts team members when replenishment is needed, potentially enabling proactive restocking before rush periods and reducing the likelihood of stockouts during high-volume operations.

A number of implementations have been described. Nevertheless, it will be understood that various modifications may be made without departing from the spirit and scope of the disclosure. Accordingly, other implementations are within the scope of the following claims.

While various aspects have been described, additional aspects, features, and methodologies of the claimed apparatuses will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. An apparatus for automatically dispensing condiment containers comprising:
a frame comprising at least one shelf, the at least one shelf comprising a plurality of storage bins and a respective storage bin comprising a plurality of condiment containers of one of a plurality of condiment types;
at least one condiment gripper mechanism positioned at least partially superior to the at least one shelf, the at least one condiment gripping mechanism comprising an end effector;
at least one movement mechanism configured to translate the at least one condiment gripper mechanism along a length of the at least one shelf;
at least one dispensing chute; and
at least one controller configured to control activation of the at least one movement mechanism and the at least one condiment gripper to:
retrieve a condiment container from one of the plurality of storage bins; and
release the condiment container into the at least one dispensing chute.

2. The apparatus of claim 1, wherein:
the at least one dispensing chute comprises at least a first dispensing chute positioned along a first side of the frame and a second dispensing chute positioned along a second side of the frame opposite the first side.

3. The apparatus of claim 2, wherein:
the frame comprises a plurality of shelves spaced vertically apart from one another, a respective shelf of the plurality of shelves comprising a respective plurality of storage bins;
respective shelves of the plurality of shelves comprise a respective first dispensing chute positioned along the first side of the frame and a respective second dispensing chute positioned along the second side of the frame; and
the at least one condiment gripper mechanism comprises a plurality of condiment gripper mechanisms, a respective condiment gripper mechanism of the plurality of condiment gripper mechanisms associated with a respective shelf of the plurality of shelves.

4. The apparatus of claim 1, further comprising at least one accumulation zone positioned at a lower portion of the frame, the at least one accumulation zone configured to receive condiment containers released through the at least one dispensing chute.

5. The apparatus of claim 4, further comprising a removable receptacle positioned at the at least one accumulation zone, the removable receptacle configured to receive dispensed condiment containers and to be lifted from the at least one accumulation zone for transfer of the dispensed condiment containers into a bag, tray, or other container.

6. The apparatus of claim 4, further comprising at least one ramp configured to guide dispensed condiment containers from the at least one dispensing chute toward the at least one accumulation zone along a descent path.

7. The apparatus of claim 1, wherein:
the at least one condiment gripper mechanism further comprises a gripper arm connecting the end effector to the at least one movement mechanism, the gripper arm configured to adjust a vertical position of the end effector between a raised position and a lowered position.

8. The apparatus of claim 7, wherein the gripper arm comprises a plurality of pivot joints configured to articulate the gripper arm between the raised position and the lowered position.

9. The apparatus of claim 1, further comprising at least one vision sensor configured to capture image data of the plurality of storage bins, wherein:
the at least one controller is configured to determine, based on the image data, positions and orientations of condiment containers within the plurality of storage bins for directing the at least one condiment gripper mechanism during retrieval operations.

10. The apparatus of claim 1, further comprising a suspension control operably coupled to the at least one controller, the suspension control configured to receive a user input and, in response to the user input, cause the at least one controller to selectively suspend or resume automated dispensing operations of the at least one condiment gripper mechanism.

11. An apparatus for automatically dispensing condiment containers, comprising:
a frame comprising a plurality of shelves spaced vertically apart from one another, a respective shelf comprising a plurality of storage bins, a respective storage bin configured to store a plurality of condiment containers of a respective condiment type;
a plurality of condiment gripper mechanisms, a respective condiment gripper mechanism positioned at least partially superior to a respective shelf and comprising:
a gripper arm comprising a plurality of pivot joints; and
an end effector connected to the gripper arm, the end effector configured to secure a condiment container via a vacuum force;
a plurality of movement mechanisms, wherein a respective movement mechanism is configured to translate a respective condiment gripper mechanism along a length of the respective shelf;
a plurality of dispensing chutes comprising a first subset of dispensing chutes positioned along a first side of the frame and a second subset of dispensing chutes positioned along a second side of the frame opposite the first side;
a plurality of accumulation zones positioned at a lower portion of the frame, a respective accumulation zone configured to receive condiment containers released through at least one of the plurality of dispensing chutes; and
at least one controller configured to:
receive order data associated with at least one order from a kitchen production system (KPS), the order data defining at least one condiment type and at least one condiment quantity;
control activation of the movement mechanism and the end effector of at least one of the plurality of condiment gripper mechanisms to retrieve a condiment container from one of the plurality of storage bins based at least in part on the order data; and
cause the at least one of the plurality of condiment gripper mechanisms to transport the condiment container to a designated dispensing chute of the plurality of dispensing chutes and release the condiment container therein for conveyance to a corresponding accumulation zone of the plurality of accumulation zones.

12. The apparatus of claim 11, further comprising:
at least one vision sensor configured to capture image data of the plurality of storage bins, wherein the at least one controller is further configured to:
determine, based on the image data, positions and orientations of condiment containers within the plurality of storage bins; and
control the at least one of the plurality of condiment gripper mechanisms to retrieve the condiment container based at least in part on the determined positions and orientations.

13. The apparatus of claim 11, wherein:
the at least one controller is further configured to:
detect a presence of a human hand within one of the plurality of storage bins; and
in response to the detection, suspend automated operations of a respective condiment gripper mechanism associated with the one of the plurality of storage bins.

14. The apparatus of claim 11, further comprising:
at least one display operably coupled to the at least one controller, wherein:
the order data defines a plurality of condiment types and a respective condiment quantity for a respective condiment type of the plurality of condiment types; and
the at least one controller is further configured to:
track dispensing of condiment containers into the designated dispensing chute;
determine, based on the tracked dispensing, that the respective condiment quantity for the respective condiment type of the plurality of condiment types associated with the at least one order has been fulfilled; and
in response to the determination, cause the at least one display to render an indication that the at least one order is complete.

15. The apparatus of claim 11, wherein:
the at least one controller is further configured to:
determine a fill level of at least one of the plurality of storage bins based at least in part on data from at least one sensor; and
cause at least one visual indicator to display a color corresponding to the determined fill level.

16. A method for automatically dispensing condiment containers, the method comprising:
receiving, by at least one controller, order data associated with at least one order, the order data defining at least one condiment type and at least one condiment quantity;
translating, based at least in part on the order data, at least one condiment gripper mechanism along a guide rail of a frame to a position aligned with a storage bin containing the at least one condiment type, the storage bin being one of a plurality of storage bins supported by the frame;
lowering an end effector of the at least one condiment gripper mechanism toward a condiment container within the storage bin;
securing the condiment container to the end effector via a vacuum force;
raising the end effector with the secured condiment container;
translating the at least one condiment gripper mechanism along the guide rail to a position aligned with a designated dispensing chute of a plurality of dispensing chutes; and
releasing the condiment container into the designated dispensing chute for conveyance to a corresponding accumulation zone.

17. The method of claim 16, further comprising:
conveying the condiment container through the designated dispensing chute to the corresponding accumulation zone; and
repeating the translating, lowering, securing, raising, translating, and releasing for at least one additional condiment container until the at least one condiment quantity is fulfilled.

18. The method of claim 16, wherein the order data is received from a kitchen production system (KPS).

19. The method of claim 16, further comprising:
detecting a presence of a human hand within one of the plurality of storage bins; and
in response to the detecting, suspending automated operations of the at least one condiment gripper mechanism for the one of the plurality of storage bins while continuing automated operations for other storage bins of the plurality of storage bins.

20. The method of claim 16, wherein:
the at least one order comprises a first order and a second order; the method further comprises:
causing a first condiment gripper mechanism to transport a first condiment container associated with the first order to a first dispensing chute and release the first condiment container therein for conveyance to a first accumulation zone; and
causing a second condiment gripper mechanism to transport a second condiment container associated with the second order to a second dispensing chute and release the second condiment container therein for conveyance to a second accumulation zone distinct from the first accumulation zone.
